(19) United States
(12) Patent Application Publication
(10) Pub. No.: US 2023/0137115 A1
(43) Pub. Date: May 4, 2023

(54) TIRE WITH LOW ROLLING RESISTANCE AND METHOD FOR PRODUCING SAME

(71) Applicant: COMPAGNIE GENERALE DES ETABLISSEMENTS MICHELIN, Clermont-Ferrand (FR)

(72) Inventors: GAEL ROTY, Clermont-Ferrand (FR); RICHARD CORNILLE, Clermont-Ferrand (FR); SABRINA RIH, Clermont-Ferrand (FR)

(21) Appl. No.: 17/768,967

(22) PCT Filed: Oct. 9, 2020
(86) PCT No.: PCT/FR2020/051793

§ 371 Date: Apr. 14, 2022

(30) Foreign Application Priority Data
Oct. 16, 2019 (FR) 1911527

(51) Int. Cl. B60C 9/20; B60C 9/00; B60C 9/22

(52) U.S. Cl. CPC B60C 9/2003; B60C 9/0042; B60C 9/2204; B60C 9/005; B60C 2009/2077; B60C 2009/2093; B60C 2009/208

(57) ABSTRACT

A tire comprises a crown reinforcement comprising: a working reinforcement comprising a single working layer and a hoop reinforcement arranged radially outside the working reinforcement and comprising at least one hooping filamentary reinforcing element (170) wound circumferentially helically so as to extend axially from one axial edge to the other axial edge of the hoop reinforcement. The or each hooping filamentary reinforcing element (170) consists of: two multifilament strands (1701, 1702) of aromatic polyamide or aromatic copolyamide and one multifilament strand (1703) of aliphatic polyamide or of polyester, or three polyester multifilament strands, each multifilament strand (1701, 1702, 1703) being wound in a helix around a main axis (W) common to the three multifilament strands (1701, 1702, 1703). The hoop reinforcement has a tangent modulus at 1.3% elongation ranging from 200 to 650 daN/mm.

The present invention relates to a tyre and to a method for producing such a tyre.

The prior art, in particular WO2019/122621 and WO2019/180367, discloses tyres comprising a crown, two sidewalls and two beads, each sidewall connecting each bead to the crown. Each bead comprises at least one circumferential reinforcing element, generally in the form of a bead wire.

The tyre also comprises a carcass reinforcement anchored in each bead and extending in each sidewall and in the crown. The carcass reinforcement comprises a single carcass layer comprising a portion wound around each circumferential reinforcing element.

The crown comprises a tread intended to come into contact with the ground when the tyre is rolling as well as a crown reinforcement arranged radially between the tread and the carcass reinforcement. The crown reinforcement comprises a working reinforcement comprising a single working layer.

The crown reinforcement also comprises a hoop reinforcement arranged radially outside the working reinforcement, the hoop reinforcement being delimited axially by two axial edges and comprising at least one hooping filamentary reinforcing element wound circumferentially helically so as to extend axially from one axial edge to the other axial edge of the hoop reinforcement in a main direction of the or each hooping filamentary reinforcing element.

As described above, the particular feature of the tyres described in WO2019/122621 and WO2019/180367 is to eliminate one working layer in relation to a conventional tyre in which the working reinforcement comprises two working layers. In such a conventional tyre, each working layer is delimited axially by two axial edges of said working layer and comprises working filamentary reinforcing elements extending axially from one axial edge to the other axial edge of said working layer substantially parallel to one another in a main direction of the working filamentary reinforcing elements forming, with the circumferential direction of the tyre, an angle, in absolute value, strictly greater than 10°, for example equal to 26°. The main direction of each working filamentary reinforcing element of one of the working layers and the main direction of each working filamentary reinforcing element of the other of the working layers form, with the circumferential direction of the tyre, in the portion of the tyre delimited axially by the axial edges of the working reinforcement, angles of opposite orientations, i.e. here +26° and −26°.

However, the tyres described in WO2019/122621 and WO2019/180367 have perfectible rolling resistance.

The object of the invention is to improve the rolling resistance of such a tyre.

Tyre According to the Invention

To this end, the invention relates to a tyre comprising a crown, two sidewalls and two beads, each sidewall connecting each bead to the crown, the tyre comprising a carcass reinforcement anchored in each bead and extending in each sidewall and radially internally at the crown, the carcass reinforcement comprising a carcass layer, the crown comprising:
a tread intended to come into contact with the ground when the tyre is rolling,
a crown reinforcement arranged radially between the tread and the carcass reinforcement, the crown reinforcement comprising:
a working reinforcement comprising a single working layer,
a hoop reinforcement arranged radially outside the working reinforcement, the hoop reinforcement being delimited axially by two axial edges of the hoop reinforcement and comprising at least one hooping filamentary reinforcing element wound circumferentially helically so as to extend axially from one axial edge to the other axial edge of the hoop reinforcement.

According to the invention, the or each hooping filamentary reinforcing element consists of:
two multifilament strands of aromatic polyamide or aromatic copolyamide and one multifilament strand of aliphatic polyamide or of polyester, or
three polyester multifilament strands, each multifilament strand being wound in a helix around a main axis common to the three multifilament strands.

Still in accordance with the invention, the hoop reinforcement has a tangent modulus at 1.3% elongation ranging from 200 to 650 daN/mm.

The tyre according to the invention has improved rolling resistance, that is to say less than that of the tyres of the prior art. For the purposes of their research, the inventors behind the invention determined that the tangent modulus at 1.3% elongation was representative of the operation of the tyre with regard to the rolling resistance of a tyre comprising a single working ply. The relevance of this tangent modulus at 1.3% elongation is demonstrated in the part relating to the comparative tests.

The tyres described in WO2019/122621 include a hoop reinforcement having a tangent modulus at 1.3% elongation that is relatively low and in any case less than 200 daN/mm. The inventors have determined that, in a tyre with a single working layer, a tangent modulus at 1.3% elongation that is too low does not make it possible to ensure a sufficient hooping function, especially since the presence of a single working layer further reduces the hooping capacity of the crown reinforcement compared with a conventional tyre comprising two working layers. A relatively low tangent modulus at 1.3% elongation makes the crown reinforcement of the tyre too dissipative and therefore increases the rolling resistance of the tyre. By contrast, the tyre according to the invention has a tangent modulus at 1.3% elongation that is sufficiently high to allow sufficient hooping of the tyre, despite the presence of a single working layer.

The tyres described in WO2019/180367 include a hoop reinforcement having a tangent modulus at 1.3% elongation that is relatively high and in any case greater than 650 daN/mm. The inventors have determined that, in a tyre with a single working layer, too high a tangent modulus at 1.3% elongation prevents good flattening of the tyre. Indeed, a relatively high tangent modulus at 1.3% elongation makes the crown reinforcement of the tyre so rigid that it is then necessary to apply a relatively high force to this crown reinforcement to ensure good flattening of the tyre. Such a force generates shearing forces in the materials, for example the elastomeric matrices, present near the axial edges of the hoop reinforcement in order to flatten the tyre. These shears cause additional dissipation, which increases the rolling resistance of the tyre. By contrast, the tyre according to the invention has a tangent modulus at 1.3% elongation that is sufficiently high but moderate to allow good flattening of the tyre, despite the presence of a single working layer.

An essential feature of the invention is to use hooping filamentary reinforcing elements constituted by three multifilament strands wound together in a helix around a common axis. Indeed, such filamentary reinforcing elements only require two twisting steps at most, which allows a rapid and inexpensive production method. By contrast, the hooping filamentary reinforcing elements described in WO2019/122621 require a step of twisting each core and layer strand as well as a step of twisting the core and layer strands together, which either makes the method relatively long or requires a large number of twisting means. As for the hooping filamentary reinforcing elements described in WO2019/180367, it is necessary to implement three successive twisting steps and to do so on a large number of twisting means, which makes the method both long and requiring a large number of twisting means.

In addition, the inventors behind the invention have identified that, unlike a tyre comprising two working layers in which the hoop reinforcement exclusively performs the function of hooping the crown reinforcement of the tyre, the hoop reinforcement of the tyre according to the invention must perform, in addition to its hooping function, other functions such as, for example, ensuring the take-up of a greater proportion of the circumferential tensions of the tyre during inflation, during rolling and in centrifugation, as well as ensuring a greater contribution to the guiding function of the tyre through its cornering stiffness. In order to perform these other functions, it is necessary to have available a hooping filamentary reinforcing element having a force-elongation curve which can be adjusted as a function of the performance compromise desired for the tyre. Each hooping filamentary reinforcing element consisting of three strands has a force-elongation curve that can be adjusted by modifying one or more parameters chosen from at least four parameters, namely the count of each multifilament strand and the twisting of these multifilament strands to form the hooping filamentary reinforcing element. On the contrary, the force-elongation curve of a hooping filamentary reinforcing element consisting of two multifilament strands could not be adjusted so well in so far as it is only possible to modify a smaller number of parameters.

According to the invention, the working reinforcement comprises a single working layer. The presence of a single working layer makes it possible in particular to lighten the tyre, therefore to reduce the energy dissipated by hysteresis of the crown and therefore to reduce the rolling resistance of the tyre. Thus, the working reinforcement is, with the exception of the working layer, devoid of any layer reinforced by filamentary reinforcing elements. The filamentary reinforcing elements of such reinforced layers excluded from the working reinforcement of the tyre comprise metallic filamentary reinforcing elements and textile filamentary reinforcing elements. Very preferably, the working reinforcement is formed by the single working layer.

In the tyre according to the invention, the hoop reinforcement is radially interposed between the working reinforcement and the tread.

Each multifilament strand comprises a plurality of monofilaments, the monofilaments typically having diameters ranging from 2 to 30 μm. Each multifilament strand of monofilaments comprises at least 2 elementary filaments, typically more than 10 elementary filaments, preferably more than 100 elementary filaments and more preferably more than 200 elementary filaments. A monofilament is made of a given material and denotes a monolithic filament resulting, for example, from the spinning of this material, for example by melt spinning, solution spinning or gel spinning.

The term “multifilament strand of aromatic polyamide or aromatic copolyamide” is understood to mean a multifilament strand consisting of monofilaments of linear macromolecules formed of aromatic groups linked together by amide bonds of which at least 85% are directly linked to two aromatic rings, and more particularly of fibres of poly(p-phenylene terephthalamide) (or PPTA), manufactured for a very long time from optically anisotropic spinning compositions. Among the aromatic polyamides or aromatic copolyamides, mention may be made of polyarylamides (or PAA, notably known by the Solvay company trade name Ixef), poly(metaxylylene adipamide), polyphthalamides (or PPA, notably known by the Solvay company trade name Amodel), amorphous semiaromatic polyamides (or PA 6-3T, notably known by the Evonik company trade name Trogamid), or para-aramids (or poly(paraphenylene terephthalamide or PA PPD-T notably known by the Du Pont de Nemours company trade name Kevlar or the Teijin company trade name Twaron).

The term “polyester multifilament strand” is understood to mean a multifilament strand consisting of monofilaments of linear macromolecules formed from groups linked together by ester bonds. Polyesters are produced by polycondensation by esterification between a dicarboxylic acid, or one of the derivatives thereof, and a diol. For example, polyethylene terephthalate can be manufactured by polycondensation of terephthalic acid and ethylene glycol. Among the known polyesters, mention may be made of polyethylene terephthalate (PET), polyethylene naphthalate (PEN), polybutylene terephthalate (PBT), polybutylene naphthalate (PBN), polypropylene terephthalate (PPT) or polypropylene naphthalate (PPN).

The term “multifilament strand of aliphatic polyamide” is understood to mean a multifilament strand consisting of monofilaments of linear macromolecules of polymers or copolymers containing amide functions which do not have aromatic rings and which can be synthesized by polycondensation between a carboxylic acid and an amine. Among the aliphatic polyamides, mention may be made of nylons PA4.6, PA6, PA6.6 or else PA6.10, and in particular Zytel from the company DuPont, Technyl from the company Solvay or Rilsamid from the company Arkema.

The tangent modulus at 1.3% elongation of the hoop reinforcement is calculated from a force-elongation curve obtained by applying the standard ASTM D 885/D 885M-10a of 2014 to a hooping filamentary reinforcing element extracted from the tyre or to a hooping filamentary reinforcing element adhered before incorporation into an elastomeric matrix. From this force-elongation curve of the hooping filamentary reinforcing element is deduced the tangent modulus of the hooping filamentary reinforcing element, expressed in daN/%, by calculating the derivative of the curve at the point of elongation equal to 1.3%. The tangent modulus at 1.3% elongation of the hoop reinforcement, expressed in daN/mm, is obtained by multiplying the tangent modulus of the hooping filamentary reinforcing element by the average axial density of hooping filamentary reinforcing element(s). The average axial density of hooping filamentary reinforcing element(s) is equal, in the case of a single hooping filamentary reinforcing element, to the average number of turns of the hooping filamentary reinforcing element per mm of hoop reinforcement or, in the case of a plurality of hooping filamentary reinforcing elements, to the average number of hooping filamentary reinforcing elements per mm of hoop reinforcement. The average axial density of hooping filamentary reinforcing element(s) is determined in the axial direction of the tyre. The determination of the axial density of hooping filamentary reinforcing element(s) is carried out over an axial width corresponding to 50% of the axial width of the tyre, this axial width being axially centred on the median plane of the tyre. Thus, the average axial density of hooping filamentary reinforcing element(s) takes into account the possible radial superimpositions of a plurality of hooping filamentary reinforcing elements, for example consecutive to a lapping or else consecutive to the presence of two radially superimposed hooping layers in the hoop reinforcement. The average axial density of hooping filamentary reinforcing element(s) does not take into account the possible radial superimpositions of a plurality of hooping filamentary reinforcing elements in the axially outer portions of the tyre, that is to say located outside the central portion centred axially on the median plane of the tyre and having an axial width equal to 50% of the axial width of the tyre.

The tyres of the invention are preferably intended for passenger vehicles. Such a tyre has a section in a meridian section plane characterized by a section width S and a section height H, within the meaning of the standard of the European Tyre and Rim Technical Organisation or “ETRTO”, such that the ratio H/S, expressed as a percentage, is at most equal to 90, preferably at most equal to 80 and more preferably at most equal to 70 and is at least equal to 30, preferably at least equal to 40, and the section width S is at least equal to 115 mm, preferably at least equal to 155 mm and more preferably at least equal to 175 mm and at most equal to 385 mm, preferably at most equal to 315 mm, more preferably at most equal to 285 mm and even more preferably at most equal to 255 mm. In addition, the diameter at the hook D, defining the diameter of the tyre mounting rim, is at least equal to 12 inches, preferably at least equal to 16 inches and at most equal to 24 inches, preferably at most equal to 20 inches.

The term axial direction means the direction substantially parallel to the main axis of the tyre, that is to say the axis of rotation of the tyre.

The term circumferential direction means the direction that is substantially perpendicular both to the axial direction and to a radius of the tyre (in other words, tangent to a circle centred on the axis of rotation of the tyre).

The term radial direction means the direction along a radius of the tyre, namely any direction that intersects the axis of rotation of the tyre and is substantially perpendicular to that axis.

The term median plane of the tyre (denoted M) means the plane perpendicular to the axis of rotation of the tyre which is situated at mid-axial distance between the two beads and passes through the axial middle of the crown reinforcement.

The term equatorial circumferential plane of the tyre (denoted E) means the theoretical cylindrical surface passing through the equator of the tyre, perpendicular to the median plane and to the radial direction. The equator of the tyre is, in a meridian section plane (plane perpendicular to the circumferential direction and parallel to the radial and axial directions), the axis that is parallel to the axis of rotation of the tyre and located equidistantly between the radially outermost point of the tread that is intended to be in contact with the ground and the radially innermost point of the tyre that is intended to be in contact with a support, for example a rim, the distance between these two points being equal to H.

The term meridian plane means a plane parallel to and containing the axis of rotation of the tyre and perpendicular to the circumferential direction.

The term bead means the portion of the tyre intended to enable the tyre to be hooked onto a mounting support, for example a wheel comprising a rim. Thus, each bead is in particular intended to be in contact with a hook of the rim allowing it to be hooked.

The term main direction in which a filamentary reinforcing element extends means the direction in which the filamentary reinforcing element extends along its greatest length. The main direction in which a filamentary reinforcing element extends may be rectilinear or curved, the reinforcing element being able to describe along its main direction a rectilinear or else wavy path.

By portion of the assembly, of a layer or of the tyre lying axially between the axial edges of a wound assembly or of a layer or of a reinforcement, there is understood a portion of the assembly, of the layer or of the tyre extending axially and lying between the radial planes passing through the axial edges of the wound assembly or of the layer or of the reinforcement.

By portion of a wound assembly intended to extend axially, portion of a wound assembly extending axially or portion of a layer extending axially in radial line with a reference assembly or a reference layer, there is understood a portion of said assembly or of said layer lying between the radial projections of the axial edges of the reference assembly or of the reference layer on said assembly or said layer.

Any range of values denoted by the expression “between a and b” represents the range of values from more than a to less than b (i.e. excluding the limits a and b), whereas any range of values denoted by the expression “from a to b” means the range of values from a up to b (i.e. including the strict limits a and b).

In the tyre, the angle considered is the angle, in absolute value, which is the smaller of the two angles defined between the reference straight line, here the circumferential direction of the tyre, and the main direction in which the filamentary reinforcing element considered extends.

In the tyre and during the method, the term orientation of an angle means the direction, clockwise or anti-clockwise, in which it is necessary to turn from the reference straight line, here the circumferential direction of the support or of the tyre, defining the angle to reach the main direction in which the filamentary reinforcing element considered extends.

During the method, the angles considered formed by the main directions in which the working and carcass filamentary reinforcing elements extend are by convention angles of opposite orientations and the angle formed by the main direction in which each working filamentary reinforcing element extends is, in absolute value, the smaller of the two angles defined between the reference straight line, here the circumferential direction of the support or of the tyre, and the main direction in which the working filamentary reinforcing element extends. Thus, the angle formed by the main direction in which each working filamentary reinforcing element extends defines an orientation which is opposite to that formed by the angle of the main direction in which each carcass filamentary reinforcing element extends.

In the variant in which the or each hooping filamentary reinforcing element consists of two multifilament strands of aromatic polyamide or aromatic copolyamide and of one multifilament strand of aliphatic polyamide or of polyester, the following characteristics can be considered independently, and preferably in combination with one another:
the count of each multifilament strand of aromatic polyamide or of aromatic copolyamide ranges from 150 tex to 350 tex,
the count of each multifilament strand of aliphatic polyamide or of polyester ranges from 120 tex to 250 tex,
the assembly twist of the three multifilament strands around the common main axis ranges from 150 turns per metre to 400 turns per metre.

Advantageously, in the variant in which the or each hooping filamentary reinforcing element consists of two multifilament strands of aromatic polyamide or aromatic copolyamide and of one multifilament strand of aliphatic polyamide or of polyester, the twist coefficient K of the or each hooping filamentary reinforcing element defined by the relation K=R×[(T/(1000·ρ)]½, in which R is the assembly twist of the three multifilament strands around the common main axis, expressed in turns per metre, T is the total count of the or each hooping filamentary reinforcing element expressed in tex, and ρ is the average density of the material constituting the or each hooping filamentary reinforcing element, ranges from 140 to 260, preferably from 180 to 220 and even more preferably from 205 to 220. The term average density means the density of each multifilament strand weighted by its count.

In the variant in which the or each hooping filamentary reinforcing element consists of three polyester multifilament strands, the following characteristics can be considered independently, and preferably in combination with one another:
the count of each polyester multifilament strand ranges from 300 tex to 500 tex,
the assembly twist of the three multifilament strands around the common main axis ranges from 100 turns per metre to 250 turns per metre.

Advantageously, in the variant in which the or each hooping filamentary reinforcing element consists of three polyester multifilament strands, the twist coefficient K of the or each hooping filamentary reinforcing element defined by the relation K=R×[(T/(1000·ρ)]½, in which R is the winding twist of the three multifilament strands around the common main axis, expressed in turns per metre, T is the total count of the or each hooping filamentary reinforcing element expressed in tex, and ρ is the density of the polyester constituting the or each hooping filamentary reinforcing element, ranges from 120 to 260, preferably from 130 to 200 and even more preferably from 130 to 160.

The twists and the count (or linear density) of each strand are determined according to the standard ASTM D 885/D 885M-10a of 2014. The count is given in tex (weight in grams of 1000 m of product—as a reminder: 0.111 tex is equal to 1 denier).

Whatever the variant envisaged, the or each hooping filamentary reinforcing element is preferably twist-balanced. The term twist-balanced means that all the monofilaments have an identical twist around their own axis, regardless of the multifilament strand to which they belong. In order to obtain such a twist-balanced hooping filamentary reinforcing element, the or each hooping filamentary reinforcing element is obtained by a method comprising the following steps:
a step of twisting each multifilament strand according to a number of turns per metre N1 in a first direction of twisting,
a step of assembling by twisting the three multifilament strands according to a number of turns per metre N2 in a second direction of twisting opposite to the first direction of twisting around the common main axis. Preferably, N1=N2 so that each monofilament exhibits substantially zero twist around its own axis.

In a particularly preferred embodiment making it possible to have more means for adjusting the force-elongation curve of the or each hooping filamentary reinforcing element, the or each hooping filamentary reinforcing element consists of two multifilament strands of aromatic polyamide or aromatic copolyamide and of one multifilament strand of aliphatic polyamide or of polyester, each multifilament strand being wound in a helix around a main axis common to the three multifilament strands. Specifically, on the one hand, thanks to two different materials, it is easier to be able to adjust the mechanical properties of the or each hooping filamentary reinforcing element. On the other hand, since the tyre according to the invention has only a single working layer, the hoop reinforcement is much more stressed than in a tyre comprising two hooping layers. Thus, a hooping filamentary reinforcing element comprising two multifilament strands of aromatic polyamide or aromatic copolyamide makes it possible to take up more forces and thus compensate for the loss of a working layer.

Thus, even more preferably, the ratio of the total count, expressed in tex, of aromatic polyamide or aromatic copolyamide to the total count, expressed in tex, of the or each hooping filamentary reinforcing element ranges from 0.60 to 0.90, preferably from 0.65 to 0.80.

Advantageously, in order to ensure improved hooping of the tyre, the hoop reinforcement has a tangent modulus at 1.3% elongation greater than or equal to 220 daN/mm.

Advantageously, in order to further improve the flattening of the tyre, the hoop reinforcement has a tangent modulus at 1.3% elongation less than or equal to 600 daN/mm, preferably less than or equal to 500 daN/mm.

In one embodiment making it possible to achieve the expected volume of the tyre and above all to contain the increase in volume during inflation of the tyre, the hoop reinforcement develops, under a force equal to 2 daN/mm, a tangent modulus ranging from 150 to 400 daN/mm.

The inventors behind the invention have also identified that the tangent modulus under a force equal to 2 daN/mm was representative of the force applied to the hoop reinforcement of a tyre comprising a single working ply during the inflation of the latter. The relevance of this tangent modulus under a force equal to 2 daN/mm of elongation is demonstrated in the part relating to the comparative tests.

The tangent modulus is calculated under a force equal to 2 daN/mm from a force-elongation curve obtained by applying the standard ASTM D 885/D 885M-10a of 2014 to a hooping filamentary reinforcing element of the hoop reinforcement. The axial density of hooping filamentary reinforcing element(s) per mm of hoop reinforcement is also determined. This axial density is determined in the axial direction of the tyre. Then, by dividing 2 daN/mm by the axial density of hooping filamentary reinforcing element(s) per mm of hoop reinforcement, we obtain the force for the hooping filamentary reinforcing element equivalent to the force of 2 daN/mm of the hoop reinforcement. The tangent modulus M2′D of the hooping filamentary reinforcing element, expressed in daN/%, is deduced by calculating the derivative of the curve at the point of this equivalent force, then the tangent modulus M2D of the hoop reinforcement, expressed in daN/mm, is deduced therefrom by multiplying the tangent modulus M2′D by the axial density of hooping filamentary reinforcing element(s) per mm of hoop reinforcement.

The inventors have determined that, in a tyre with a single working layer, a hoop reinforcement developing, under a force equal to 2 daN/mm, an excessively low tangent modulus did not make it possible to create a hoop reinforcement providing a sufficient hooping function and all the more so since the single working layer further lowered the hooping capacity of the crown reinforcement compared with a conventional tyre comprising two working layers. An important consequence is that, with too low a tangent modulus, the hoop reinforcement of a tyre with a single working layer does not make it possible to contain its volume when the tyre is pressurized. The external dimensions then achieved by the tyre would then be significantly different from the expected dimensions that make it possible to obtain the expected performance of the tyre.

The inventors have also determined that, in a tyre with a single working layer, a hooping ply developing, under a force equal to 2 daN/mm, an excessively high tangent modulus could cause a radially inward penetration of the or each hooping filamentary reinforcing element during the moulding step.

Advantageously, in order to improve the hooping of the tyre, the hoop reinforcement develops, under a force equal to 2 daN/mm, a tangent modulus greater than or equal to 200 daN/mm.

Advantageously, in order to reduce the risk of the or each hooping filamentary reinforcing element penetrating into the working reinforcement, the hoop reinforcement develops, under a force equal to 2 daN/mm, a tangent modulus less than or equal to 350 daN/mm.

Advantageously, in order to improve the performance of the tyre, in particular in terms of cornering stiffness and at high speed, the or each hooping filamentary reinforcing element extends axially from one axial edge to the other axial edge of the hoop reinforcement in a main direction of the or each hooping filamentary reinforcing element forming, with the circumferential direction of the tyre, an angle, in absolute value, less than or equal to 10°, preferably less than or equal to 7° and more preferably less than or equal to 5°.

Advantageously, the working layer is delimited axially by two axial edges of the working layer and comprises working filamentary reinforcing elements extending axially from one axial edge to the other axial edge of the working layer substantially parallel to one another in a main direction of each working filamentary reinforcing element, the main direction of each working filamentary reinforcing element of the working layer forming, with the circumferential direction of the tyre, an angle, in absolute value, strictly greater than 10°, preferably ranging from 15° to 50° and more preferably from 18° to 30°.

In an advantageous embodiment making it possible to retain the advantages of a tyre in which the carcass filamentary reinforcing elements extend substantially radially in each sidewall and having a crown reinforcement having a triangular mesh, the or each carcass layer is delimited axially by two axial edges of the or each carcass layer and comprises carcass filamentary reinforcing elements extending axially from one axial edge to the other axial edge of the or each carcass layer, each carcass filamentary reinforcing element extending in a main direction of each carcass filamentary reinforcing element, the main direction of each carcass filamentary reinforcing element of the or each carcass layer forming, with the circumferential direction of the tyre:
an angle, in absolute value, strictly less than 80° in a portion of the carcass layer extending axially in radial line with the working layer,
an angle, in absolute value, ranging from 80° to 90° in at least one portion of the carcass layer extending radially in each sidewall.

In one variant of this embodiment in which the angle of each carcass filamentary reinforcing element differs between the sidewall and radially in line with the working layer, the carcass reinforcement comprises a single carcass layer. In this variant, the carcass reinforcement is, with the exception of the single carcass layer, devoid of any layer reinforced by filamentary reinforcing elements. The filamentary reinforcing elements of such reinforced layers excluded from the carcass reinforcement of the tyre comprise metallic filamentary reinforcing elements and textile filamentary reinforcing elements. Very preferably, the carcass reinforcement consists of the single carcass layer.

In another variant of this embodiment in which the angle of each carcass filamentary reinforcing element differs between the sidewall and radially in line with the working layer, the carcass reinforcement comprises two carcass layers, the main directions of the carcass filamentary reinforcing elements of the two carcass layers being substantially parallel to one another.

In embodiments in which the main direction of each carcass filamentary reinforcing element has, between the portions, transition zones where the angle is substantially variable, the portion of the or each carcass layer extending axially in line with the working layer and in which the main direction of each carcass filamentary reinforcing element forms, with the circumferential direction of the tyre, an angle, in absolute value, strictly less than 80° has an axial width equal to at least 40%, preferably at least 50%, of the axial width of the working layer.

In embodiments in which the main direction of each carcass filamentary reinforcing element has, between the portions, transition zones where the angle is substantially variable, the portion of the or each carcass layer extending axially in line with the working layer and in which the main direction of each carcass filamentary reinforcing element forms, with the circumferential direction of the tyre, an angle, in absolute value, strictly less than 80° has an axial width equal to at most 90%, preferably at most 80%, of the axial width of the working layer.

Preferably, the median plane of the tyre intersects this portion of the or each carcass layer extending axially in line with the working layer. More preferably, this portion of the or each carcass layer extending axially in line with the working layer is axially centred on the median plane of the tyre.

In embodiments in which the main direction of each carcass filamentary reinforcing element has, between the portions, transition zones where the angle is substantially variable, each portion of the or each carcass layer extending radially in each sidewall and in which the main direction of each carcass filamentary reinforcing element forms, with the circumferential direction of the tyre, an angle, in absolute value, ranging from 80° to 90° has a radial height equal to at least 5%, preferably at least 15% and more preferably at least 30%, of the radial height of the tyre.

In embodiments in which the main direction of each carcass filamentary reinforcing element has, between the portions, transition zones where the angle is substantially variable, each portion of the or each carcass layer extending radially in each sidewall and in which the main direction of each carcass filamentary reinforcing element forms, with the circumferential direction of the tyre, an angle, in absolute value, ranging from 80° to 90° a radial height equal to at most 80%, preferably at most 70% and more preferably at most 60%, of the radial height of the tyre.

Preferably, the equatorial circumferential plane of the tyre intersects each of these portions of the or each carcass layer located in each sidewall.

In the embodiment in which the angle of each carcass filamentary reinforcing element differs between the sidewall and in radial line with the working layer, a preferential compromise in performance of the tyre is obtained when the main direction of each carcass filamentary reinforcing element forms, with the circumferential direction of the tyre, an angle, in absolute value, greater than or equal to 10°, preferably ranging from 20° to 75° and more preferably ranging from 35° to 70°, in the portion of the carcass layer extending axially in radial line with the working layer.

In the tyre according to the invention, the crown comprises the tread and the crown reinforcement. The tread is understood to be a strip of polymeric, preferably elastomeric, material delimited:
radially towards the outside by a surface intended to be in contact with the ground and
radially towards the inside by the crown reinforcement.

The strip of polymeric material is formed by a layer of a polymeric, preferably elastomeric, material or else formed by a stack of a number of layers, each layer consisting of a polymeric, preferably elastomeric, material.

In an advantageous embodiment, the crown reinforcement comprises a single hoop reinforcement and a single working reinforcement. Thus, the crown reinforcement is, with the exception of the hoop reinforcement and the working reinforcement, devoid of any reinforcement reinforced by filamentary reinforcing elements. The filamentary reinforcing elements of such reinforcements excluded from the crown reinforcement of the tyre comprise metallic filamentary reinforcing elements and textile filamentary reinforcing elements. Very preferably, the crown reinforcement consists of the hoop reinforcement and the working reinforcement.

In a very preferred embodiment, the crown is, with the exception of the crown reinforcement, devoid of any reinforcement reinforced by filamentary reinforcing elements. The filamentary reinforcing elements of such reinforcements excluded from the crown of the tyre comprise metallic filamentary reinforcing elements and textile filamentary reinforcing elements. Very preferably, the crown consists of the tread and the crown reinforcement.

In a very preferred embodiment, the carcass reinforcement is arranged so as to be directly radially in contact with the crown reinforcement and the crown reinforcement is arranged so as to be directly radially in contact with the tread. In this very preferred embodiment, the hoop reinforcement and the working layer are advantageously arranged so as to be directly radially in contact with one another.

The expression directly radially in contact means that the objects in question that are directly radially in contact with one another, in this case the layers, reinforcements or the tread, are not separated radially by any object, for example by any layer, reinforcement or strip interposed radially between the objects in question that are directly radially in contact with one another.

So as to preferentially guarantee effective triangulation of the crown of the tyre, the main direction of the or each hooping filamentary reinforcing element, the main direction of each working filamentary reinforcing element and the main direction of each carcass filamentary reinforcing element form, with the circumferential direction of the tyre, in a portion of the tyre lying axially between the axial edges of the axially narrowest layer or reinforcement among the working layer and the hoop reinforcement, paired angles different in absolute value. This is also referred to as a triangular mesh formed by the hooping, working and carcass filamentary reinforcing elements.

In other words, with the or each hooping filamentary reinforcing element extending in a main hooping direction, each working filamentary reinforcing element extending in a main working direction, each carcass filamentary reinforcing element extending in a main carcass direction, these hooping, working and carcass directions are in pairs that are different in the portion of the tyre delimited axially by the axial edges of the axially narrowest layer or reinforcement among the working layer and the hoop reinforcement.

In embodiments in which the main direction of each carcass filamentary reinforcing element has, between the portions, transition zones where the angle is substantially variable, the portion of the tyre lying axially between the axial edges of the axially narrowest layer or reinforcement among the working layer and the hoop reinforcement and in which the main direction of the or each hooping filamentary reinforcing element, the main direction of each working filamentary reinforcing element and the main direction of each carcass filamentary reinforcing element form, with the circumferential direction of the tyre, paired angles different in absolute value has an axial width equal to at least 40%, preferably at least 50%, of the axial width of the working layer.

In embodiments in which the main direction of each carcass filamentary reinforcing element has, between the portions, transition zones where the angle is substantially variable, the portion of the tyre lying axially between the axial edges of the axially narrowest layer or reinforcement among the working layer and the hoop reinforcement and in which the main direction of the or each hooping filamentary reinforcing element, the main direction of each working filamentary reinforcing element and the main direction of each carcass filamentary reinforcing element form, with the circumferential direction of the tyre, paired angles different in absolute value has an axial width equal to at most 90%, preferably at most 80%, of the axial width of the working layer.

Preferably, the median plane of the tyre intersects this portion of the tyre lying axially between the axial edges of the axially narrowest layer or reinforcement among the working layer and the hoop reinforcement. More preferably, this portion of the tyre lying axially between the axial edges of the axially narrowest layer or reinforcement among the working layer and the hoop reinforcement is axially centred on the median plane of the tyre.

In order to further improve the triangulation of the crown of the tyre in the embodiment in which the angle of each carcass filamentary reinforcing element differs between the sidewall and in radial line with the working layer, the main direction of each working filamentary reinforcing element and the main direction of each carcass filamentary reinforcing element form, with the circumferential direction of the tyre, in a portion of the tyre lying axially between the axial edges of the working layer, angles of opposite orientations.

In embodiments in which the main direction of each carcass filamentary reinforcing element has, between the portions, transition zones where the angle is substantially variable, the portion of the tyre lying axially between the axial edges of the working layer and in which the main direction of each working filamentary reinforcing element and the main direction of each carcass filamentary reinforcing element form, with the circumferential direction of the tyre, angles of opposite orientations has an axial width equal to at least 40%, preferably at least 50%, of the axial width of the working layer.

In embodiments in which the main direction of each carcass filamentary reinforcing element has, between the portions, transition zones where the angle is substantially variable, the portion of the tyre lying axially between the axial edges of the working layer and in which the main direction of each working filamentary reinforcing element and the main direction of each carcass filamentary reinforcing element form, with the circumferential direction of the tyre, angles of opposite orientations has an axial width equal to at most 90%, preferably at most 80%, of the axial width of the working layer.

Preferably, the median plane of the tyre intersects this portion of the tyre lying axially between the axial edges of the working layer. More preferably, this portion of the tyre lying axially between the axial edges of the working layer is axially centred on the median plane of the tyre.

In one embodiment making it possible to easily anchor the carcass reinforcement in each bead, each bead comprises at least one circumferential reinforcing element, the or at least one of the carcass layer(s) comprising a portion of the or at least one of the carcass layer(s) wound around each circumferential reinforcing element, the main direction of each carcass filamentary reinforcing element forms, with the circumferential direction of the tyre, an angle of each carcass filamentary reinforcing element, in absolute value, strictly greater than 0°, preferably ranging from 27° to 150° and more preferably ranging from 56° to 123°, in the wound portion of the or at least one of the carcass layer(s).

Advantageously, the filamentary reinforcing elements of each layer are embedded in an elastomeric matrix. The different layers can comprise the same elastomeric matrix or else different elastomeric matrices.

An elastomeric matrix is understood to be a matrix that exhibits elastomeric behaviour in the crosslinked state. Such a matrix is advantageously obtained by crosslinking a composition comprising at least one elastomer and at least one other component. Preferably, the composition comprising at least one elastomer and at least one other component comprises an elastomer, a crosslinking system and a filler. The compositions used for these layers are conventional compositions for calendering reinforcers, typically based on natural rubber or other diene elastomer, a reinforcing filler such as carbon black, a curing system and usual additives. The adhesion between the filamentary reinforcing elements and the matrix in which they are embedded is ensured for example by an ordinary adhesive composition, for example an adhesive of the RFL type or an equivalent adhesive.

Advantageously, each working filamentary reinforcing element is metallic. The term metallic filamentary element is understood to mean a filamentary element formed from one or an assembly of a plurality of elementary monofilaments made entirely (for 100% of the threads) of a metallic material. Such a metallic filamentary element is preferably implemented with one or more threads made of steel, more preferably of pearlitic (or ferritic-pearlitic) carbon steel referred to as “carbon steel” below, or else made of stainless steel (by definition steel comprising at least 11% chromium and at least 50% iron). However, it is of course possible to use other steels or other alloys. If a carbon steel is advantageously used, its carbon content (% by weight of steel) preferably ranges from 0.05% to 1.2%, notably from 0.5% to 1.1%; these contents represent a good compromise between the mechanical properties required for the tyre and the feasibility of the threads. The metal or the steel used, whether it is in particular a carbon steel or a stainless steel, may itself be coated with a metallic layer which improves for example the properties of implementing the metallic cord and/or of its constituent elements, or the use properties of the cord and/or of the tyre themselves, such as the properties of adhesion, corrosion resistance or else resistance to ageing. According to a preferred embodiment, the steel used is covered with a layer of brass (Zn—Cu alloy) or of zinc. Each metallic elementary monofilament is, as described above, preferably made of carbon steel, and has a mechanical strength ranging from 1000 MPa to 5000 MPa. Such mechanical strengths correspond to the steel grades commonly encountered in the field of tyres, namely the NT (Normal Tensile), HT (High Tensile), ST (Super Tensile), SHT (Super High Tensile), UT (Ultra Tensile), UHT (Ultra High Tensile) and MT (Mega Tensile) grades, the use of high mechanical strengths potentially allowing improved reinforcement of the matrix in which the cord is intended to be embedded and lightening of the matrix reinforced in this way. The or the assembly of a plurality of elementary monofilaments can be coated with a polymeric material, for example as described in US20160167438.

Method According to the Invention

Another subject of the invention is a method for producing a tyre as described above in which:
there is formed, by winding a carcass ply or a plurality of carcass plies around a support having a substantially cylindrical shape around a main axis, one or more wound carcass assembly(ies), the wound carcass assembly(ies) being intended to form the carcass layer(s),
there is formed, by winding a working ply or a plurality of working plies, radially outside the wound carcass assembly(ies), a wound working assembly intended to form the working layer, the wound carcass assembly(ies) and the wound working assembly forming an assembly of substantially cylindrical shape around the main axis of the support,
the assembly of substantially cylindrical shape around the main axis of the support is deformed so as to obtain an assembly of substantially toric shape around the main axis of the support, after the deformation step, there is arranged, radially around the assembly of substantially toric shape around the main axis of the support, a wound hooping assembly intended to form the hoop reinforcement, the wound hooping assembly being formed by helical winding of the or each hooping filamentary reinforcing element or of a hooping ply obtained by embedding the or each hooping filamentary reinforcing element in an elastomeric matrix.

A carcass assembly may be intended to form a single carcass layer or else be intended to form two carcass layers by winding this carcass assembly over two turns around the sealing assembly. Thus, in one embodiment in which the tyre comprises two carcass layers, it is possible to form a single carcass assembly wound over two turns around the sealing assembly or else to form a first radially internal carcass assembly wound around the sealing assembly and a second radially external carcass assembly wound around the first radially internal carcass assembly, each first and second carcass assembly forming each carcass layer.

In the context of the invention, the working assembly is intended to form the single working layer.

In a simplified method in which only one carcass ply has to be handled to form each wound carcass assembly and in which there would be avoided circumferential junctions between a plurality of carcass plies of axial widths smaller than the axial width of each wound carcass assembly intended to be formed, each wound carcass assembly consists of a carcass ply which is intended to form each carcass layer. In other words, each carcass ply is axially continuous.

In the case where each wound carcass assembly is formed with a plurality of carcass plies, preferably a plurality of carcass plies will be used in which the main directions of the carcass filamentary reinforcing elements are all parallel to one another.

Similarly, in a simplified method in which only one working ply has to be handled to form the wound working assembly and in which there would be avoided circumferential junctions between a plurality of working plies of axial widths smaller than the axial width of the wound working assembly intended to be formed, the wound working assembly consists of a working ply which is intended to form the single working layer. In other words, the working ply is axially continuous.

In the case where the wound working assembly is formed with a plurality of working plies, preferably a plurality of working plies will be used in which the main directions of the working filamentary reinforcing elements are all parallel to one another. Of course, main directions of the working filamentary reinforcing elements that are not parallel to one another from one working ply to the other may be considered.

During the method according to the invention, the step of forming the hooping assembly is carried out so that the or each hooping filamentary reinforcing element extends axially from one axial edge to the other axial edge of the hooping assembly in a main direction of the or each hooping filamentary reinforcing element. The angle formed by the main direction of the or each hooping filamentary reinforcing element with the circumferential direction of the support is advantageously, in absolute value, less than or equal to 10°, preferably less than or equal to 7° and more preferably less than or equal to 5°.

The term median plane of the assembly (denoted m) means the plane perpendicular to the main axis of the support which is located at mid-axial distance, between each axial edge of the assembly.

The term equatorial circumferential plane of the assembly (denoted e) means the theoretical cylindrical surface passing through the equator of the assembly, perpendicular to the median plane and to the radial direction. The equator of the assembly is, in a meridian section plane (plane perpendicular to the circumferential direction and parallel to the radial and axial directions), the axis parallel to the main axis of the support and located equidistant between the radially outermost point of the assembly and the radially innermost point of the assembly, the distance between these two points being equal to h.

The method preferably comprises steps during which:
a green blank of the tyre formed from the assembly formed beforehand and the wound hooping assembly is moulded by radially and circumferentially expanding the green blank so as to press a radially outer surface of the green blank against a moulding wall of a crosslinking mould,
the green blank is crosslinked in the crosslinking mould so as to obtain the tyre.

Very advantageously, in order to prevent the or each hooping filamentary reinforcing element from penetrating into the working reinforcement which is radially inside it during the moulding step, the wound hooping assembly develops, under a force equal to 2 daN/mm, a tangent modulus ranging from 155 to 420 daN/mm.

Before the embedding step, the hooping filamentary reinforcing element is adhered. An adhered filamentary reinforcing element is such that the textile material(s) constituting the filamentary reinforcing element are directly or indirectly (in the case of a filamentary reinforcing element having been pre-adhered) coated with an external layer intended to ensure adhesion between the raw or pre-adhered filamentary reinforcing element and the matrix. It is thus possible to use a conventional aqueous adhesive composition of RFL (Resorcinol-Formaldehyde-Latex of elastomer(s)) type or else as described in WO2013017421 or WO2017/168107.

The term pre-adhered means a filamentary reinforcing element such that the textile material(s) constituting the filamentary reinforcing element are directly coated with an intermediate layer of a composition intended to promote adhesion between the textile material(s) constituting the filamentary reinforcing element and an external layer of a composition which itself is intended to ensure adhesion between the pre-adhered textile filamentary element and the matrix in which the filamentary reinforcing element will be embedded once the latter is adhered. The intermediate composition layer of the pre-adhered filamentary reinforcing element cannot by itself ensure adhesion of the same quality as the external layer. An intermediate layer is advantageously used in the case of relatively non-polar textile materials, for example in the case of aromatic polyamides or aromatic copolyamides or of certain polyesters.

In one variant, it is possible to envisage the fact that, in the case where the wound hooping assembly is formed by helical winding of the hooping filamentary reinforcing element, the hooping filamentary reinforcing element is adhered.

In another variant, it is possible to envisage the fact that, in the case where the wound hooping assembly is formed by helical winding of the hooping filamentary reinforcing element, the hooping filamentary reinforcing element is adhered, the external composition layer intended to ensure adhesion being coated with a layer of elastomeric composition.

Advantageously, in order to improve the hooping of the tyre, before the winding step, the hooping assembly develops, under a force equal to 2 daN/mm, a tangent modulus greater than or equal to 210 daN/mm.

Advantageously, in order to reduce the risks of the or each hooping filamentary reinforcing element penetrating into the working reinforcement, before the winding step, the hooping assembly develops, under a force equal to 2 daN/mm, a tangent modulus less than or equal to 368 daN/mm.

The tangent modulus is calculated under a force equal to 2 daN/mm from a force-elongation curve obtained by applying the standard ASTM D 885/D 885M-10a of 2014 to a hooping filamentary reinforcing element of the wound hooping assembly. The axial density of hooping filamentary reinforcing element(s) per mm of wound hooping assembly is also determined. This axial density is determined in the axial direction of the support. Then, by dividing 2 daN/mm by the axial density of hooping filamentary reinforcing element(s) per mm of wound hooping assembly, we obtain the force for the hooping filamentary reinforcing element equivalent to the force of 2 daN/mm of the wound hooping assembly. The tangent modulus M2′D of the hooping filamentary reinforcing element, expressed in daN/%, is deduced by calculating the derivative of the curve at the point of this equivalent force, then the tangent modulus M2D of the wound hooping assembly, expressed in daN/mm. %, is deduced therefrom by multiplying the tangent modulus M2′D by the axial density of hooping filamentary reinforcing element(s) per mm of wound hooping assembly.

As in the tyre, the average axial density of hooping filamentary reinforcing element(s) is equal, in the case of a single hooping filamentary reinforcing element, to the average number of turns of the hooping filamentary reinforcing element per mm of wound hooping assembly or, in the case of a plurality of hooping filamentary reinforcing elements, to the average number of hooping filamentary reinforcing elements per mm of wound hooping assembly. The determination of the average axial density of hooping filamentary reinforcing element(s) is carried out over an axial width corresponding to 50% of the axial width of the tyre intended to be manufactured, this axial width being axially centred on the median plane of the support or of the assembly. Thus, the average axial density takes into account the possible radial superimpositions of a plurality of hooping filamentary reinforcing elements, for example consecutive to a lapping or else consecutive to the presence of two radially superimposed hooping assemblies.

Preferably, prior to the moulding step, a strip of polymeric material intended to form the tread is arranged radially outside the hooping assembly, so as to form the green blank.

In one embodiment making it possible to retain the properties of a radial tyre conferred by the radial carcass filamentary reinforcing elements in the sidewalls and the properties of a tyre comprising a triangulated crown reinforcement, the or each wound carcass assembly being delimited axially by two axial edges of the or each wound carcass assembly and comprising carcass filamentary reinforcing elements extending substantially parallel to one another axially from one axial edge to the other axial edge of the or each wound carcass assembly, each carcass filamentary reinforcing element extending, in the or each carcass ply, in a main direction of each carcass filamentary reinforcing element in the or each carcass ply, the main direction of each carcass filamentary reinforcing element forming, with the circumferential direction of the support, an initial angle of each carcass filamentary reinforcing element, the assembly of substantially cylindrical shape is deformed so as to obtain the assembly of substantially toric shape so that the main direction of each carcass filamentary reinforcing element forms, with the circumferential direction of the support:
a final angle of each carcass filamentary reinforcing element, in absolute value, strictly less than 80°, in a portion of the or each wound carcass assembly extending axially in radial line with the wound working assembly,
a final angle of each carcass filamentary reinforcing element ranging, in absolute value, from 80° to 90°, in a portion of the or each wound carcass assembly intended to extend radially in each sidewall.

In embodiments in which the main direction of each carcass filamentary reinforcing element has, between the portions, transition zones where the angle is substantially variable, the portion of the or each wound carcass assembly extending axially in radial line with the wound working assembly and in which the main direction of each carcass filamentary reinforcing element forms, with the circumferential direction of the support, a final angle, in absolute value, strictly less than 80° has an axial width equal to at least 40%, preferably at least 50%, of the axial width of the wound working assembly.

In embodiments in which the main direction of each carcass filamentary reinforcing element has, between the portions, transition zones where the angle is substantially variable, the portion of the or each wound carcass assembly extending axially in radial line with the wound working assembly and in which the main direction of each carcass filamentary reinforcing element forms, with the circumferential direction of the support, a final angle, in absolute value, strictly less than 80° has an axial width equal to at most 90%, preferably at most 80%, of the axial width of the wound working assembly.

Preferably, the median plane of the assembly intersects this portion of the or each wound carcass assembly extending axially in radial line with the wound working assembly. More preferably, this portion of the or each wound carcass assembly extending axially in radial line with the wound working assembly is axially centred on the median plane of the assembly.

The axial width of the portion of the or each wound carcass assembly depends in particular on the rate of deformation as well as on the initial angles. Those skilled in the art will know, by varying one and/or the other of these parameters, how to vary the axial width of the portion of the or each wound carcass assembly concerned.

In embodiments in which the main direction of each carcass filamentary reinforcing element has, between the portions, transition zones where the angle is substantially variable, each portion of the or each wound carcass assembly intended to extend radially in each sidewall and in which the main direction of each carcass filamentary reinforcing element forms, with the circumferential direction of the support, a final angle ranging, in absolute value, from 80° to 90° has a radial height equal to at least 5%, preferably at least 15% and even more preferably at least 30%, of the radial height of the tyre produced.

In embodiments in which the main direction of each carcass filamentary reinforcing element has, between the portions, transition zones where the angle is substantially variable, each portion of the or each wound carcass assembly intended to extend radially in each sidewall and in which the main direction of each carcass filamentary reinforcing element forms, with the circumferential direction of the support, a final angle ranging, in absolute value, from 80° to 90° has a radial height equal to at most 80%, preferably at most 70% and even more preferably at most 60%, of the radial height of the tyre produced.

Preferably, the equatorial circumferential plane of the assembly intersects each portion of the or each wound carcass assembly intended to be located in each sidewall.

Similarly, the radial height of the portion of the or each wound carcass assembly depends in particular on the rate of deformation as well as on the initial angles. Those skilled in the art will know, by varying one and/or the other of these parameters, how to vary the radial height of each portion of the or each wound carcass assembly concerned.

In order to obtain, at the end of the deformation step, final angles allowing a preferential compromise in performance of the tyre, the initial angle formed by the main direction of each carcass filamentary reinforcing element with the circumferential direction of the support is, in absolute value, strictly greater than 0°, preferably ranges from 27° to 150° and more preferably ranges from 56° to 123°.

Such a preferential compromise in performance of the tyre is obtained when the final angle formed by the main direction of each carcass filamentary reinforcing element with the circumferential direction of the support is, in absolute value, greater than or equal to 10°, preferably ranges from 20° to 75° and more preferably ranges from 35 to 70°, in the portion of the or each wound carcass assembly extending axially in radial line with the wound working assembly.

In one embodiment making it possible to preserve the properties of a tyre comprising a triangulated crown reinforcement, the wound working assembly being delimited axially by two axial edges of the wound working assembly and comprising working filamentary reinforcing elements extending substantially parallel to one another axially from one axial edge to the other axial edge of the wound working assembly, each working filamentary reinforcing element extending, in the or each working ply, in a main direction of each working filamentary reinforcing element in the or each working ply, the main direction of each working filamentary reinforcing element in the or each working ply forming, with the circumferential direction of the support, an initial angle of each working filamentary reinforcing element, the assembly of substantially cylindrical shape around the main axis of the support is deformed so as to obtain the assembly of substantially toric shape around the main axis of the support, so that the main direction of each working filamentary reinforcing element forms, with the circumferential direction of the support, a final angle of each working filamentary reinforcing element, in absolute value, strictly greater than 10°.

In order to obtain, at the end of the deformation step, final angles allowing a preferential compromise in performance of the tyre, the initial angle formed by the main direction of each working filamentary reinforcing element with the circumferential direction of the support is, in absolute value, strictly greater than 0°, preferably ranges from 4° to 60° and more preferably ranges from 16° to 47°.

Such a preferential compromise in performance of the tyre is obtained when the final angle formed by the main direction of each working filamentary reinforcing element with the circumferential direction of the support ranges, in absolute value, from 15° to 50°, preferably from 18° to 30°.

In some embodiments, the final angle formed by the main direction of each working filamentary reinforcing element with the circumferential direction of the support is substantially equal to the angle formed by the main direction of each working filamentary reinforcing element of the working layer with the circumferential direction of the tyre once the latter has been manufactured. Similarly, in these same embodiments, the final angle formed by the main direction of each carcass filamentary reinforcing element with the circumferential direction of the support in the portion of the wound carcass assembly extending axially in radial line with the wound working assembly is substantially equal to the angle formed by the main direction of each carcass filamentary reinforcing element of the carcass layer(s) with the circumferential direction of the tyre in the portion of the carcass layer(s) extending axially in radial line with the working layer once the tyre has been manufactured.

In other embodiments, a slight decrease in the final angles may occur during the step of moulding the green blank in the mould during which the green blank is pressed against moulding surfaces of the mould and undergoes non-negligible radial moulding deformation relative to the deformation undergone during the deformation step to change the assembly of the wound carcass assembly and the wound working assembly from the substantially cylindrical shape to the substantially toric shape.

In preferred embodiments making it possible to obtain effective triangulation, the main direction of the or each hooping filamentary reinforcing element, the main direction of each working filamentary reinforcing element and the main direction of each carcass filamentary reinforcing element form, with the circumferential direction of the support, in a portion of the assembly and of the wound hooping assembly lying axially between the axial edges of the axially narrowest wound assembly among the wound working assembly and the wound hooping assembly, paired angles different in absolute value.

The portion of the assembly and of the wound hooping assembly lying axially between the axial edges of the axially narrowest wound assembly among the wound working assembly and the wound hooping assembly and in which the main direction of the or each hooping filamentary reinforcing element, the main direction of each working filamentary reinforcing element and the main direction of each carcass filamentary reinforcing element form, with the circumferential direction of the support, paired angles different in value absolute has an axial width equal to at least 40%, preferably at least 50%, of the axial width of the wound working assembly.

The portion of the assembly and of the wound hooping assembly lying axially between the axial edges of the axially narrowest wound assembly among the wound working assembly and the wound hooping assembly and in which the main direction of the or each hooping filamentary reinforcing element, the main direction of each working filamentary reinforcing element and the main direction of each carcass filamentary reinforcing element form, with the circumferential direction of the support, paired angles different in value absolute has an axial width equal to at most 90%, preferably at most 80%, of the axial width of the wound working assembly.

Preferably, the median plane of the assembly intersects this portion of the assembly and of the wound hooping assembly lying axially between the axial edges of the axially narrowest wound assembly among the wound working assembly and the wound hooping assembly. More preferably, this portion of the assembly and of the wound hooping assembly lying axially between the axial edges of the axially narrowest wound assembly among the wound working assembly and the wound hooping assembly is axially centred on the median plane of the assembly.

In the method described above, the initial angles formed with the circumferential direction of the support by the main directions of the carcass and working filamentary reinforcing elements vary during the deformation step to reach their final angles, except for the wound portion of the carcass assembly wound around the circumferential reinforcing elements in which the main direction of the carcass filamentary reinforcing elements remains substantially identical with respect to the circumferential direction of the support and therefore of the tyre.

The variation in the angle of the main direction of the carcass and working filamentary reinforcing elements can be determined by those skilled in the art depending on the rate of deformation used during the method. The rate of deformation is determined in a manner known to those skilled in the art as a function of the axial drawing together of the axial edges of the wound carcass assembly(ies) and of the radial enlargement of the assembly between its cylindrical shape and its toric shape. The determination of the initial angles as a function of the final angles depends, in a manner known to those skilled in the art, on the rate of deformation as explained in FR2797213 and in FR1413102.

In one embodiment making it possible to easily anchor the carcass reinforcement in each bead, after the step of forming the or at least one of the wound carcass assembly(ies):
two circumferential reinforcing elements are arranged around the or at least one of the wound carcass assembly(ies),
each axial edge of the or at least one of the wound carcass assembly(ies) is turned axially inwardly so as to radially cover each circumferential reinforcing element by one of the axial edges of the or at least one of the wound carcass assembly(ies) and to form a portion of the or at least one of the wound carcass assembly(ies) wound around each circumferential reinforcing element,
the assembly of substantially cylindrical shape is deformed so as to obtain the assembly of substantially toric shape so that the main direction of each carcass filamentary reinforcing element forms, with the circumferential direction of the support, a final angle of each carcass filamentary reinforcing element, in absolute value, strictly less than 80° in the wound portion of the or at least one of the wound carcass assembly(ies).

In the embodiment described above, the final angle formed by the main direction of each carcass filamentary reinforcing element, with the circumferential direction of the support, in the wound portion of the or at least one of the wound carcass assembly(ies) is substantially identical to the initial angle formed by the main direction of each carcass filamentary reinforcing element before the deformation step due to the anchoring of this portion around the circumferential reinforcing element.

### DESCRIPTION OF THE EXAMPLES

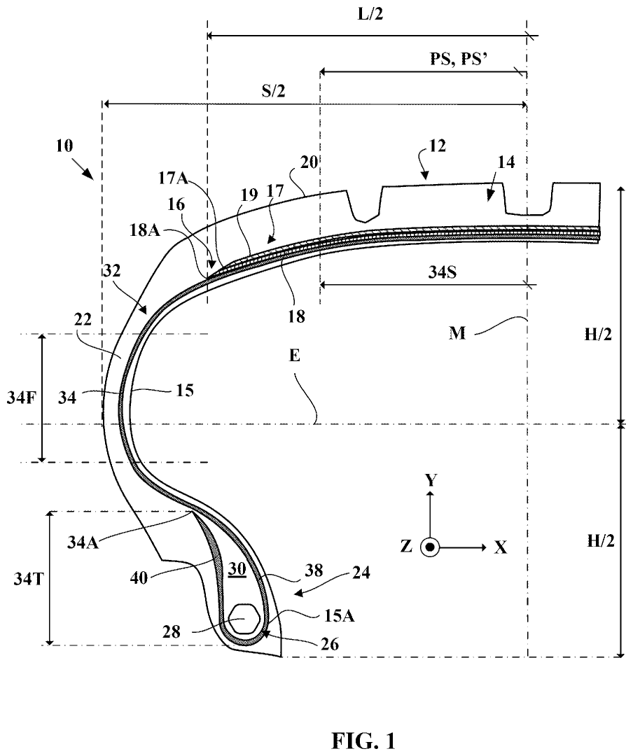

The invention as well as its advantages will be easily understood in the light of the detailed description and the nonlimiting exemplary embodiments which follow, as well as from FIGS. 1 to 20 relating to these examples in which:

FIG. 1 is a view in section in a meridian section plane of a tyre according to the invention;

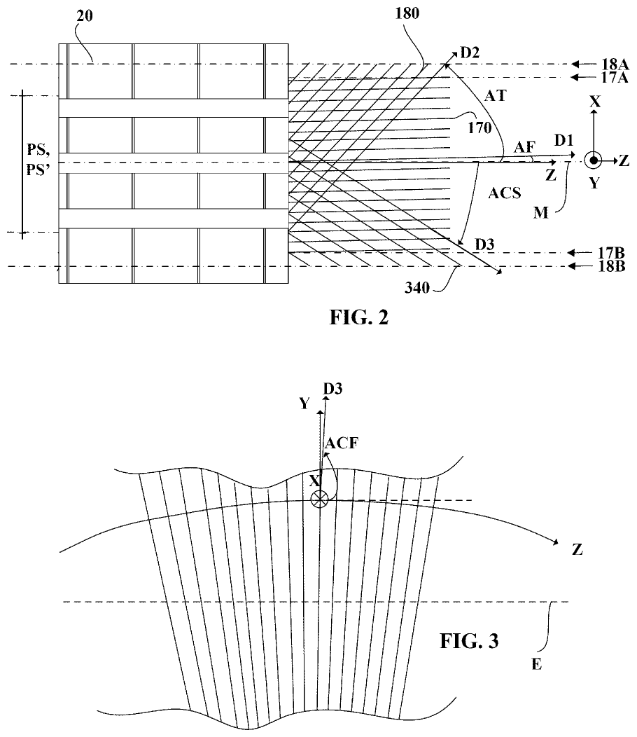

FIG. 2 is a schematic cutaway view of the tyre of FIG. 1 illustrating the arrangement of the filamentary reinforcing elements in radial line with and radially overhanging the working layer;

FIG. 3 is a schematic view of the carcass filamentary reinforcing elements arranged in the sidewall of the tyre of FIG. 1;

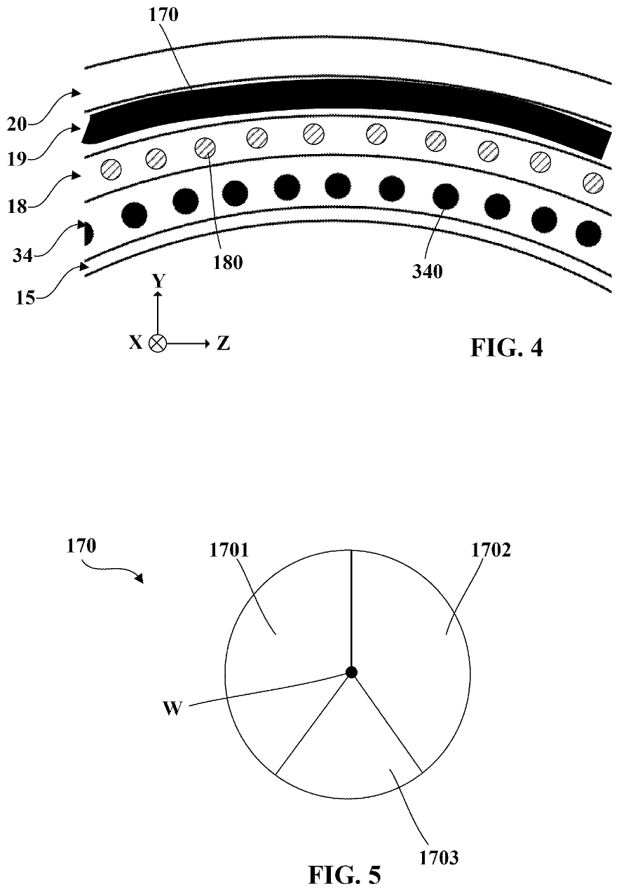

FIG. 4 is a view in a section plane perpendicular to the axial direction of a portion of the crown of the tyre of FIG. 1;

FIG. 5 is a view in a section plane perpendicular to the main direction in which each hooping filamentary reinforcing element of the tyre of FIG. 1 extends;

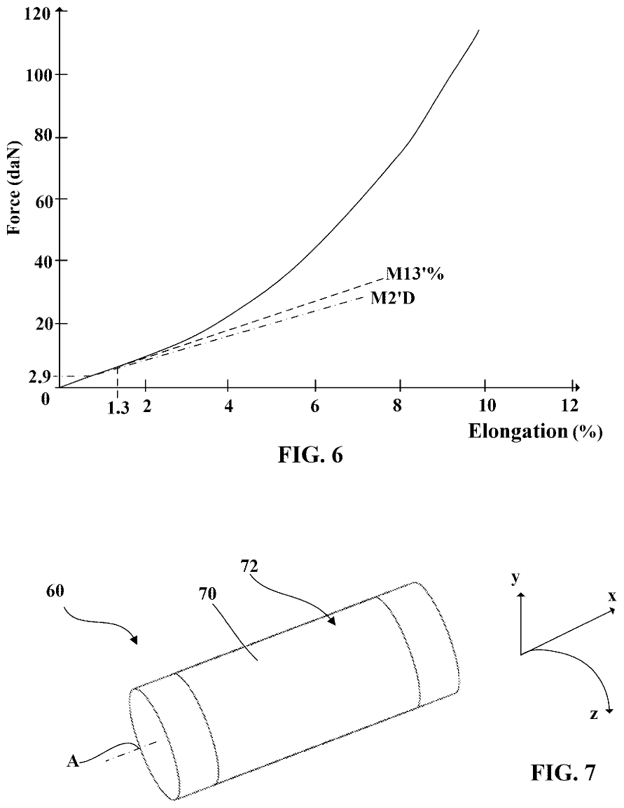

FIG. 6 is a force-elongation curve of a hooping filamentary reinforcing element of the tyre of FIG. 1;

FIGS. 7 to 16 illustrate the different steps of the method according to the invention making it possible to manufacture the tyre of FIG. 1;

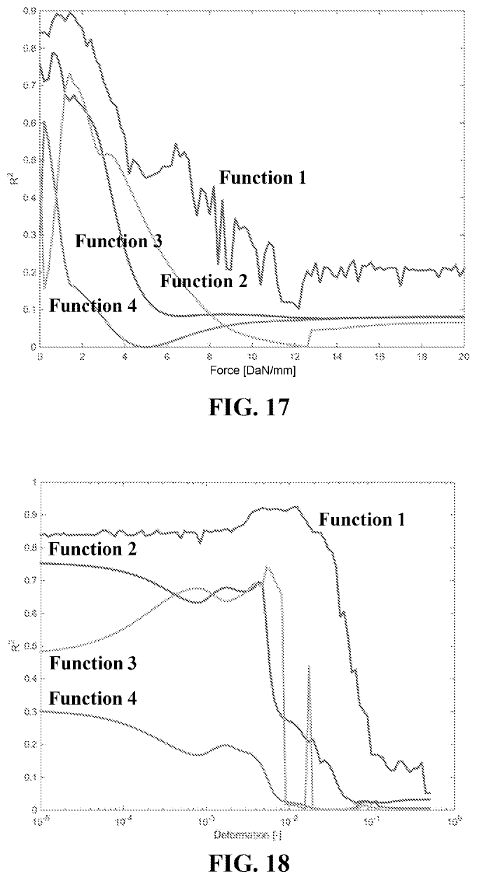

FIGS. 17 and 18 illustrate, for different models, the coefficient of correlation R2 between the simulated rolling resistance and the tangent modulus of the hoop reinforcement for a tyre according to the invention respectively with imposed force and with imposed elongation, and

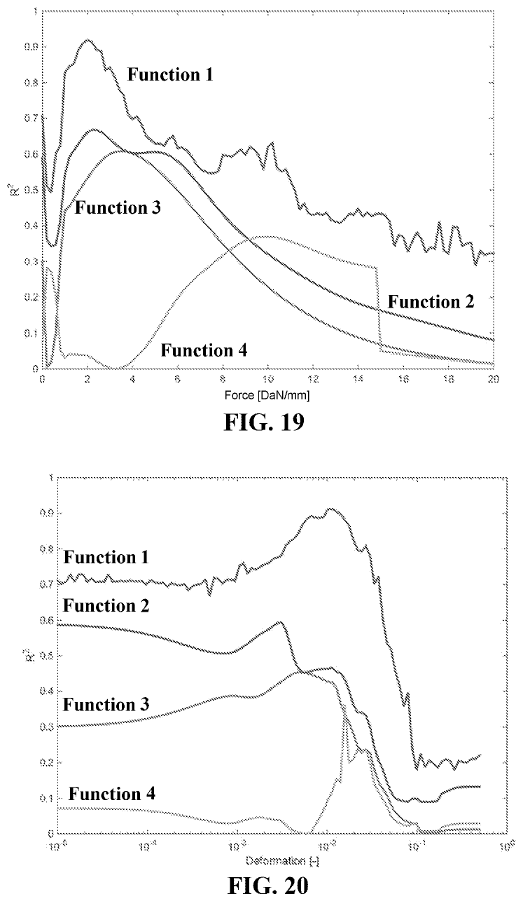

FIGS. 19 and 20 illustrate, for different models, the coefficient of correlation R2 between the simulated rolling resistance and the tangent modulus of the hoop reinforcement for a conventional tyre respectively with imposed force and with imposed elongation.

In the figures relating to the tyre, there is shown a reference frame X, Y, Z corresponding to the usual axial (X), radial (Y) and circumferential (Z) directions, respectively, of a tyre. In the figures relating to the method, there is shown a reference frame x, y, z corresponding to the usual axial (x), radial (y) and circumferential (z) directions, respectively, of a manufacturing support deformable between a substantially cylindrical shape and a toric shape around the x axis.

FIG. 1 shows a tyre according to the invention and denoted by the general reference 10. The tyre 10 is substantially of revolution about an axis substantially parallel to the axial direction X. The tyre 10 is here intended for a passenger vehicle and has dimensions 245/45R18.

The tyre 10 comprises a crown 12 comprising a tread 20 intended to come into contact with the ground during rolling and a crown reinforcement 14 extending in the crown 12 in the circumferential direction Z. The tyre 10 also comprises a sealing layer 15 for sealing against an inflation gas being intended to define an internal cavity closed with a mounting support for the tyre 10 once the tyre 10 has been mounted on the mounting support, for example a rim. The sealing layer 15 comprises an elastomeric composition comprising an elastomeric matrix comprising at least 50 phr of one or more butyl elastomers.

The crown reinforcement 14 comprises a working reinforcement 16 comprising a working layer 18 and a hoop reinforcement 17 comprising a single hooping layer 19. Here, the working reinforcement 16 comprises a single working layer 18 and, in this case, consists of the single working layer 18. In the following description, mention will be made, for the sake of simplification, of the working layer 18 without restating each time that this layer is single. The hoop reinforcement 17 consists of the hooping layer 19.

The crown reinforcement 14 is surmounted radially by the tread 20. Here, the hoop reinforcement 17, here the hooping layer 19, is arranged radially outside the working reinforcement 16 and is therefore radially interposed between the working reinforcement 16 and the tread 20. In the embodiment illustrated in FIG. 2, the hoop reinforcement 17 has an axial width smaller than the axial width of the working layer 18. Thus, the hoop reinforcement 17 is axially the narrowest of the working layer 18 and of the hoop reinforcement 17.

The tyre 10 comprises two sidewalls 22 extending the crown 12 radially inwards. The tyre 10 further comprises two beads 24 radially inside the sidewalls 22. Each sidewall 22 connects each bead 24 to the crown 12.

Each bead 24 comprises at least one circumferential reinforcing element 26, in this case a bead wire 28 surmounted radially by a mass of filling rubber 30.

The tyre 10 comprises a carcass reinforcement 32 anchored in each bead 24. The carcass reinforcement 32 extends in each sidewall 22 and radially inwardly at the crown 12. The crown reinforcement 14 is arranged radially between the tread 20 and the carcass reinforcement 32.

The carcass reinforcement 32 comprises a carcass layer 34. Here, the carcass reinforcement 32 comprises a single carcass layer 34, and in this case consists of the single carcass layer 34. In this embodiment, mention will be made, for the sake of simplification, of the carcass layer 34 without restating each time that this layer is single.

The carcass layer 34 comprises a portion 34T of the carcass layer 34 wound around each circumferential reinforcing element 26 so as to form in each bead 24 an axially inner portion 38 and an axially outer portion 40. The mass of filling rubber 30 is interposed between the axially inner and outer portions 38, 40. Other methods of anchoring the carcass layer 34 are possible, for example as described in U.S. Pat. No. 5,702,548.

Each working 18, hooping 19 and carcass 34 layer comprises an elastomeric matrix in which are embedded one or more filamentary reinforcing elements of the corresponding layer. These layers will now be described with reference to FIGS. 1 to 4.

The hoop reinforcement 17, here the hooping layer 19, is delimited axially by two axial edges 17A, 17B of the hoop reinforcement 17. The hoop reinforcement 17 comprises a plurality of hooping filamentary reinforcing elements 170 wound circumferentially helically so as to extend axially from the axial edge 17A to the other axial edge 17B of the hooping layer 17 in a main direction D1 of each hooping filamentary reinforcing element 170. The main direction D1 forms, with the circumferential direction Z of the tyre 10, an angle AF, in absolute value, less than or equal to 10°, preferably less than or equal to 7° and more preferably less than or equal to 5°. Here, AF=−5°. The hoop reinforcement has an average axial density of 69 threads per decimetre, or 0.69 threads per mm.

The working layer 18 is delimited axially by two axial edges 18A, 18B of the working layer 18. The working layer 18 comprises working filamentary reinforcing elements 180 extending axially from the axial edge 18A to the other axial edge 18B of the working layer 18 substantially parallel to one another. Each working filamentary reinforcing element 180 extends in a main direction D2 of each working filamentary reinforcing element 180. The direction D2 forms, with the circumferential direction Z of the tyre 10, an angle AT, in absolute value, strictly greater than 10°, preferably ranging from 15° to 50° and more preferably ranging from 18° to 30°. Here, AT=24°.

The carcass layer 34 is delimited axially by two axial edges 34A, 34B of the carcass layer 34. The carcass layer 34 comprises carcass filamentary reinforcing elements 340 extending axially from the axial edge 34A to the other axial edge 34B of the carcass layer 34.

Each carcass filamentary reinforcing element 340 extends in a main direction D3 of each carcass filamentary reinforcing element 340 forming, with the circumferential direction Z of the tyre 10, an angle ACS, in absolute value, strictly less than 80° in a portion 34S of the carcass layer 34 extending axially in radial line with the working layer 18. Advantageously, in this portion 34S of the carcass layer 34 extending axially in radial line with the working layer 18, the main direction D3 of each carcass filamentary reinforcing element 340 forms, with the circumferential direction Z of the tyre 10, an angle ACS, in absolute value, greater than or equal to 10°, preferably ranging from 20° to 75° and more preferably ranging from 35° to 70°. Here, ACS=43°.

The portion 34S of the carcass layer 34 extending axially in line with the working layer 18 has an axial width equal to at least 40%, preferably at least 50%, of the axial width L of the working layer 18 and equal to at most 90%, preferably at most 80%, of the axial width L of the working layer 18 and in this case equal to 60% of the working layer 18. The median plane M of the tyre 10 intersects this portion 34S. More preferably, this portion 34S is axially centred on the median plane M of the tyre 10.

As illustrated in FIGS. 1 and 3, the main direction D3 of each carcass filamentary reinforcing element 340 forms, with the circumferential direction Z of the tyre 10, an angle ACF, in absolute value, ranging from 80° to 90° in at least one portion 34F of the carcass layer 34 extending radially in each sidewall 22. Here, ACF=90°.

Each portion 34F of the carcass layer 34 extending radially in each sidewall 22 has a radial height equal to at least 5%, preferably at least 15% and more preferably at least 30%, of the radial height H of the tyre 10 and equal to at most 80%, preferably at most 70% and more preferably at most 60%, of the radial height H of the tyre 10 and in this case equal to 41% of the radial height H of the tyre 10. The equatorial circumferential plane E of the tyre 10 intersects each portion 34F of the carcass layer 34 located in each sidewall 22.

The main direction D3 of each carcass filamentary reinforcing element 340 forms, with the circumferential direction Z of the tyre 10, an angle ACT, in absolute value, strictly greater than 0°, preferably ranging from 27° to 150° and more preferably ranging from 56° to 123°, in the wound portion 34T of the carcass layer 34.

As illustrated in FIG. 2, the main direction D1 of each of hooping filamentary reinforcement 170, the main direction D2 of each working filamentary reinforcing element 180 and the main direction D3 of each carcass filamentary reinforcing element 340 form, with the circumferential direction Z of the tyre 10, in a portion PS′ of the tyre 10 lying axially between the axial edges 17A, 17B of the hoop reinforcement 17, paired angles different in absolute value. In addition, the main direction D2 of each working filamentary reinforcing element 180 and the main direction D3 of each carcass filamentary reinforcing element 340 form, with the circumferential direction Z of the tyre 10, in a portion PS of the tyre 10 lying axially between the axial edges 18A, 18B of the working layer 18, angles AT and ACS of opposite orientations. In this case, AT=−24° and ACS=+43°.

In the embodiment described, each portion PS, PS′ of the tyre 10 has an axial width equal to at least 40%, preferably at least 50%, of the axial width L of the working layer 18 and equal to at most 90%, preferably at most 80%, of the axial width L of the working layer 18 and in this case equal to 60% of the axial width L of the working layer 18. The median plane M of the tyre 10 intersects each portion PS, PS′ of the tyre 10. More preferably, each portion PS, PS′ of the tyre 10 is axially centred on the median plane M of the tyre 10.

Each working filamentary reinforcing element 180 is an assembly of two steel monofilaments that each have a diameter equal to 0.30 mm, the two steel monofilaments being wound together at a pitch of 14 mm.

Each carcass filamentary reinforcing element 340 conventionally comprises two multifilament strands, each multifilament strand consisting of a monofilament yarn of polyesters, here of PET, these two multifilament strands being individually over-twisted at 240 turns per metre in one direction and then twisted together at 240 turns per metre in the opposite direction. These two multifilament strands are wound in a helix around one another. Each of these multifilament strands has a count equal to 220 tex.

As illustrated in FIG. 5, each hooping filamentary reinforcing element 170 consists of three multifilament strands 1701, 1702, 1703, and in this case consists of two multifilament strands 1701, 1702 of aromatic polyamide or aromatic copolyamide and of one multifilament strand 1703 of aliphatic polyamide or of polyester, and here consists of two multifilament strands 1701, 1702 of aromatic polyamide, for example of Kevlar from the company Dupont Maydown, and of one multifilament strand 1703 of aliphatic polyamide, for example of Nylon T728 from the company Kordsa. Each multifilament strand 1701, 1702, 1703 is wound in a helix around a main axis W common to the three multifilament strands.

The count of each multifilament strand of aromatic polyamide 1701, 1702 ranges from 150 tex to 350 tex and in this case is equal to 330 tex. The count of the multifilament strand of aliphatic polyamide 1703 ranges from 120 tex to 250 tex and in this case is equal to 188 tex. The ratio of the total count, expressed in tex, of aromatic polyamide to the total count, expressed in tex, of each hooping filamentary reinforcing element 170 ranges from 0.60 to 0.90, preferably from 0.65 to 0.80 and is here equal to 0.78.

Each hooping filamentary reinforcing element 170 is twist-balanced and is obtained by a method comprising a first step of twisting each multifilament strand 1701, 1702, 1703 according to a number of turns per metre N1 in a first direction of twisting. The method comprises a second step of assembling by twisting the three multifilament strands 1701, 1702, 1703 according to a number of turns per metre N2 in a second direction of twisting opposite to the first direction of twisting around the common main axis W, with here N1=N2. The assembly twist N2 of the three multifilament strands 1701, 1702, 1703 around the common main axis W ranges from 150 turns per metre to 400 turns per metre and in this case N2=270 turns per metre.

The twist coefficient K of each hooping filamentary reinforcing element 170 described above ranges from 140 to 260, preferably from 180 to 220 and even more preferably from 205 to 220 and here is equal to 212 with an average density of the constituent material of each hooping filamentary reinforcing element 170 equal to 1.37 taking an aromatic polyamide density equal to 1.44 and an aliphatic polyamide density equal to 1.14.

The hoop reinforcement 17 also has a tangent modulus M13% at 1.3% elongation ranging from 200 to 650 daN/mm. The tangent modulus M13% is determined from the tangent modulus M13′% at 1.3% elongation of each hooping filamentary reinforcing element 170, illustrated in FIG. 6, which has been multiplied by the average axial density of hooping filamentary reinforcing elements 170 per mm of hoop reinforcement, and here by the average number of turns of the hooping filamentary reinforcing elements per mm of hoop reinforcement 17. Here M13′%=4.67 daN/% and N=0.69 turns per mm. More precisely, the tangent modulus M13% is greater than or equal to 220 daN/mm and less than or equal to 600 daN/mm, preferably less than or equal to 500 daN/mm and here equal to 322 daN/mm.

The hoop reinforcement 14 develops, under a force equal to 2 daN/mm, a tangent modulus M2D ranging from 150 to 400 daN/mm. More precisely, the hoop reinforcement 14 develops, under a force equal to 2 daN/mm, a tangent modulus M2D greater than or equal to 200 daN/mm and less than or equal to 350 daN/mm. In the example illustrated, taking into account the average axial density of hooping filamentary reinforcing elements 170 equal to 0.69 elements per mm, the force equal to 2 daN/mm represents a force equivalent to 2.9 daN/hooping filamentary reinforcing element, which, in FIG. 6, gives an equivalent tangent modulus M2′D equal to 4.35 daN/%, that is to say a modulus M2D equal to 300 daN/mm for the hoop reinforcement 14.

The tyre 10 is obtained by a method according to the invention which will be described with reference to FIGS. 7 to 13.

First, a wound working assembly 50 and a wound carcass assembly 52 are manufactured by arranging the filamentary reinforcing elements 180 and 340 of each assembly 50 and 52 parallel to one another and by embedding them, for example by calendering, in an uncrosslinked composition comprising at least one elastomer, the composition being intended to form an elastomeric matrix once crosslinked. A ply known as a straight ply is obtained, in which the filamentary reinforcing elements are parallel to one another and are parallel to the main direction of the ply. Then, portions of each straight ply are cut at a cutting angle and these portions are butted against one another so as to obtain a ply known as an angled ply, in which the filamentary reinforcing elements of the ply are parallel to one another and form an angle with the main direction of the ply equal to the cutting angle.

In the embodiment described, there is obtained, on the one hand, a single working ply 49 and a single carcass ply 51, the axial width of each of which, that is to say the dimension in a direction perpendicular to the longitudinal edges of each ply, is equal to the axial width respectively of each wound working 50 and carcass 52 assembly which will be formed subsequently.

Referring to FIG. 7, in a first step of assembling a green blank, there is formed, by winding a sealing ply 70 around a support 60 having a substantially cylindrical shape around its main axis A, a wound sealing assembly 72 intended to form the sealing layer 15. The support 60 has a substantially cylindrical laying surface with a radius equal to 235 mm.

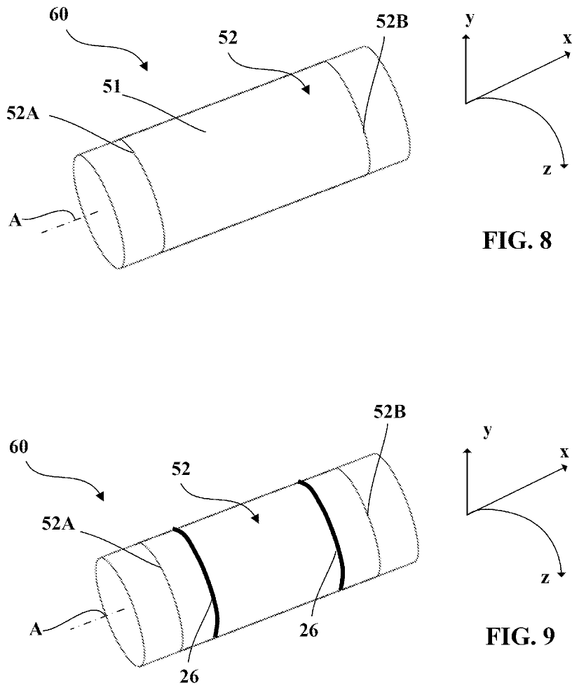

Then, with reference to FIG. 8, radially outside the wound sealing assembly 72, there is formed, by winding the carcass ply 51 around the support 60, the wound carcass assembly 52 intended to form the carcass layer 34. The wound carcass assembly 52 is axially delimited by two axial edges 52A, 52B of the carcass assembly 52 and comprises the carcass filamentary reinforcing elements 340 extending substantially parallel to one another axially from the axial edge 52A to the other axial edge 52B of the wound carcass assembly 52. Each carcass filamentary reinforcing element 340 extends, in the carcass ply 51, in a main direction K3 of each carcass filamentary reinforcing element 340 in the carcass ply 51. The main direction K3 forms, with the circumferential direction z of the support 60, an initial angle A3 of each carcass filamentary reinforcing element 340, in absolute value, strictly greater than 0°, preferably ranging from 27° to 150° and more preferably ranging from 56° to 123°. Here A3=75°.

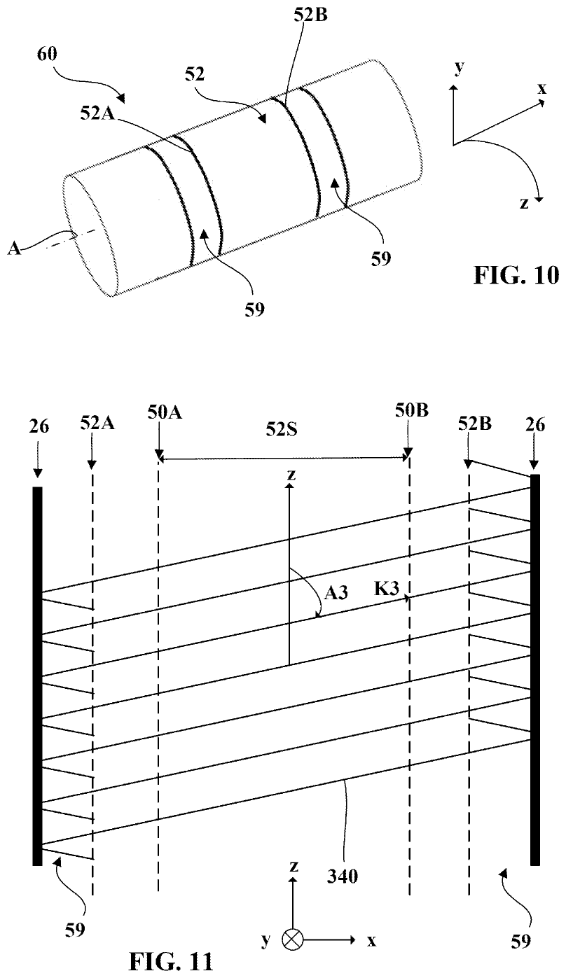

Referring to FIGS. 9 and 10, then, the two circumferential reinforcing elements 26 are arranged around the wound carcass assembly 52 and each axial edge 52A, 52B of the wound carcass assembly 52 is turned axially inwards so as to radially cover each circumferential reinforcing element 26 by each axial edge 52A, 52B of the wound carcass assembly 52 and to form a portion 59 of the wound carcass assembly 52 wound around each circumferential reinforcing element 26. The portion 59 of the wound carcass assembly 52 is intended to form the portion 34T of the carcass layer 34 wound around each circumferential reinforcing element 26 in the tyre.

There is shown in FIG. 11 a diagram illustrating the arrangement of the carcass filamentary reinforcing elements 340 at the end of the step of axially turning the axial edges 52A, 52B of the wound carcass assembly 52 around the circumferential reinforcing elements 26. In this FIG. 11, there is shown the initial angle A3 described above as well as each portion 59.

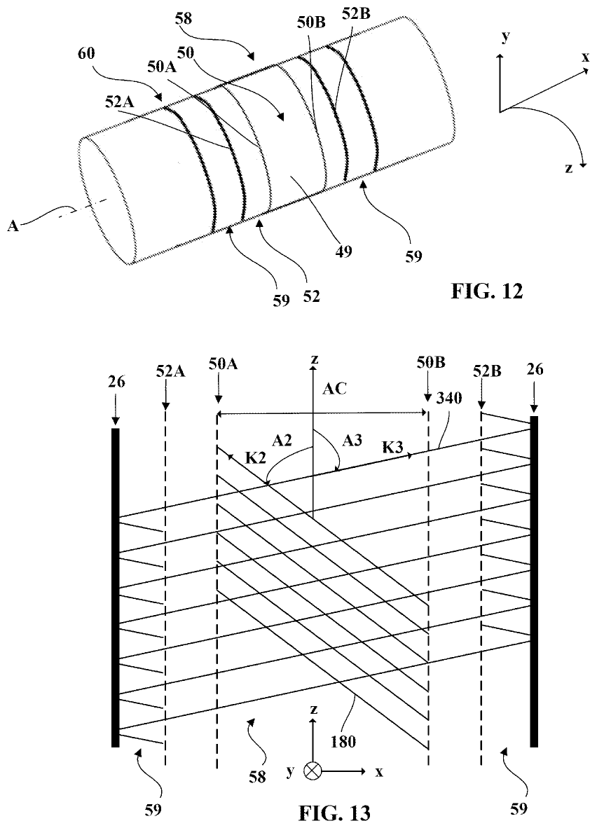

Then, with reference to FIG. 12, there is formed, by winding the working ply 49, radially outside the wound carcass assembly 52, the wound working assembly 50 intended to form the working layer 18. The wound working assembly 50 is axially delimited by two axial edges 50A, 50B of the wound working assembly 50 and comprises the working filamentary reinforcing elements 180 extending substantially parallel to one another axially from the axial edge 50A to the other axial edge 50B of the wound working assembly 50. Each working filamentary reinforcing element 180 extends, in the working ply 49, in a main direction K2 of each working filamentary reinforcing element 180 in the working ply 49. With reference to FIG. 13, the main direction K2 forms, with the circumferential direction z of the support 60, an initial angle A2 of each working filamentary reinforcing element 180, in absolute value, strictly greater than 0°, preferably ranging from 4° to 60° and more preferably ranging from 16° to 47°. Here, A2=35°.

The wound carcass assembly 52 and the wound working assembly 50 then form an assembly 58 of substantially cylindrical shape around the main axis A of the support 60.

There is shown in FIG. 13 a diagram similar to that of FIG. 11 illustrating the arrangement of the carcass filamentary reinforcing elements 340 and the working filamentary reinforcing elements 180 at the end of the step of forming the wound working assembly 50. In this FIG. 13, the initial angles A2 and A3 have been shown.

The main direction K2 of each working filamentary reinforcing element 180 and the main direction K3 of each carcass filamentary reinforcing element 340 form, with the circumferential direction z of the support 60, in a portion AC of the assembly 58 lying axially between the axial edges 50A, 50B of the wound working assembly 50, initial angles A2 and A3 of opposite orientations. Here, the axial width of the portion AC is substantially equal to the axial width of the wound working assembly 50. In this case, A2=−35° and A3=+75°.

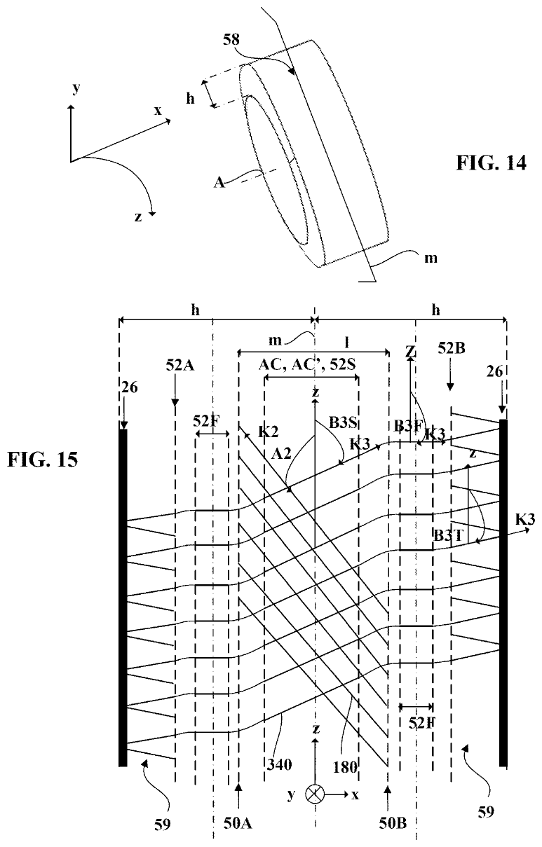

Then, the assembly 58 of substantially cylindrical shape around the main axis A of the support 60 is deformed so as to obtain the assembly 58 of substantially toric shape around the main axis A of the support 60. The deformed assembly 58 illustrated in FIG. 14 is obtained. The laying surface of the support 60 then has, at the level of the median plane of the support, a radius equal to 327 mm.

Referring to FIG. 15, the assembly 58 of substantially cylindrical shape around the main axis A of the support 60 is deformed so as to obtain an assembly 58 of substantially toric shape around the main axis A of the support 60 so that the main direction K3 of each carcass filamentary reinforcing element 340 forms, with the circumferential direction z of the support 60, a final angle B3S of each carcass filamentary reinforcing element 340, in absolute value, strictly less than 80°, in a portion 52S of the wound carcass assembly 52 extending axially in radial line with the wound working assembly 50. Advantageously, the final angle B3S is, in absolute value, greater than or equal to 10°, preferably ranges from 20° to 75° and more preferably ranges from 35 to 70°. Here, B3S=43°. The portion 52S of the wound carcass assembly 52 is intended to form the portion 34S of the carcass layer 34.

The portion 52S of the wound carcass assembly 52 extending axially in radial line with the wound working assembly 50 has an axial width equal to at least 40%, preferably at least 50%, of the axial width I of the wound working assembly 50 and equal to at most 90%, preferably at most 80%, of the axial width I of the wound working assembly 50 and, in this case, is equal to 60% of the axial width I of the wound working assembly 50. The median plane m of the assembly 58 intersects this portion 52S. More preferably, this portion 52S is axially centred on the median plane m of the assembly 58.

The assembly 58 of substantially cylindrical shape around the main axis A of the support 60 is deformed so as to obtain the assembly 58 of substantially toric shape around the main axis A of the support 60 also so that the main direction K3 of each carcass filamentary reinforcing element 340 forms, with the circumferential direction z of the support 60, a final angle B3F of each carcass filamentary reinforcing element 340 ranging, in absolute value, from 80° to 90°, in a portion 52F of the wound carcass assembly 52 intended to extend radially in each sidewall 22 of the tyre 10. Each portion 52F of the wound carcass assembly 52 is intended to form each portion 34F of the carcass layer 34.

Each portion 52F of the wound carcass assembly 52 intended to extend radially in each sidewall 22 has a radial height equal to at least 5%, preferably at least 15% and even more preferably at least 30%, of the radial height H of the manufactured tyre and equal to at most 80%, preferably at most 70% and even more preferably at most 60%, of the radial height H of the manufactured tyre, and in this case is equal to 41% of the radial height H of the manufactured tyre. The equatorial circumferential plane e of the assembly 58 intersects each portion 52F of the wound carcass assembly 52 intended to be located in each sidewall 22.

During the deformation step, the final angle B3T formed by the main direction K3 of each carcass filamentary reinforcing element 340, with the circumferential direction z of the support 60, in the wound portion 59 of the wound carcass assembly 52, is substantially identical to the initial angle A3 before the deformation step.

The assembly 58 of substantially cylindrical shape around the main axis A of the support 60 is deformed so as to obtain the assembly 58 of substantially toric shape around the main axis A of the support 60 also so that the main direction K2 of each working filamentary reinforcing element 340 forms, with the circumferential direction z of the support 60, a final angle B2 of each working filamentary reinforcing element 340, in absolute value, strictly greater than 10°. Advantageously, the final angle B2 ranges, in absolute value, from 15° to 50°, preferably from 18° to 30° and here B2=24°.

The main direction K2 of each working filamentary reinforcing element 180 and the main direction K3 of each carcass filamentary reinforcing element 340 form, with the circumferential direction z of the support 60, in the portion AC of the assembly 58 lying axially between the axial edges 50A, 50B of the wound working assembly 50, final angles B2 and B3S of opposite orientations. In this case, B2=−24° and B3S=+43°.

During the method, a plurality of hooping filamentary reinforcing elements 170, preferably adhered, are embedded in an elastomeric matrix to form a hooping ply 74.

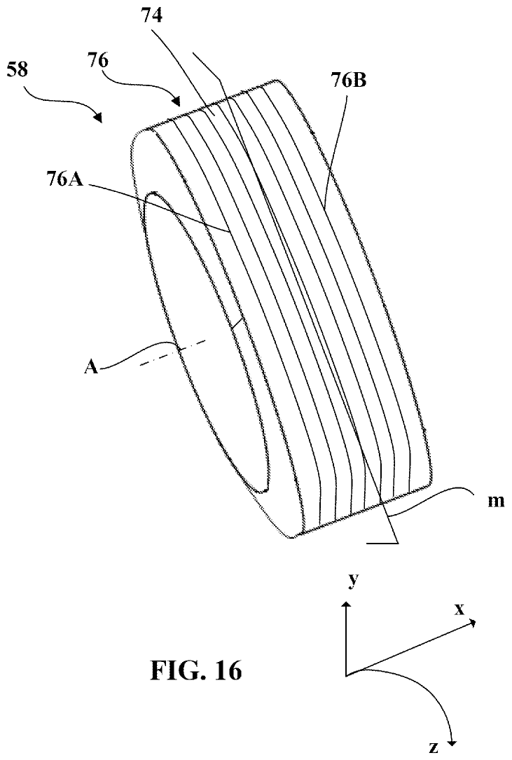

Then, as illustrated in FIG. 16, there is arranged, radially around the assembly 58 previously formed on the support 60, a wound hooping assembly 76 intended to form the hoop reinforcement 17. Here, the wound hooping assembly 76 is formed by helical winding of the hooping ply 74 on a toric shape and then the wound hooping assembly 76 is transferred using a transfer ring radially outside the assembly 58 previously formed. As a variant, the hooping ply 74 may be directly wound circumferentially helically around the assembly 58 previously formed so as to form the wound hooping assembly 76.

The wound hooping assembly 76 develops, under a force equal to 2 daN/mm, a tangent modulus M2D ranging from 155 to 420 daN/mm. More precisely, the hooping assembly 76 develops, under a force equal to 2 daN/mm, a tangent modulus M2Dc greater than or equal to 210 daN/mm and less than or equal to 368 daN/mm. In the example illustrated, the average axial density of hooping filamentary reinforcing elements 170 in the wound hooping assembly 76 is slightly less than that of the hoop reinforcement 17, in this case equal to 0.66 elements per mm, the force equal to 2 daN/mm represents a force equivalent to 3.03 daN/hooping filamentary reinforcing element, which corresponds to an equivalent tangent modulus M2′Dc equal to 4.57 daN/%, i.e. a modulus M2Dc equal to 301 daN/mm for the wound hooping assembly 76.

In the illustrated embodiment, the wound hooping assembly 76 has an axial width smaller than the axial width of the wound working assembly 50. Thus, the wound hooping assembly 76 is axially the narrowest of the wound working 50 and wound hooping 76 assemblies.

The angle A1 formed by the main direction K1 of each hooping filamentary reinforcing element 170 with the circumferential direction z of the support 60 is, in absolute value, less than or equal to 10°, preferably less than or equal to 7° and more preferably less than or equal to 5° and here equal to 5°.

The main direction K1 of each hooping filamentary reinforcing element 170, the main direction K2 of each working filamentary reinforcing element 180 and the main direction D3 of each carcass filamentary reinforcing element 340 form, with the circumferential direction z of the support 60, in a portion AC′ of the assembly 58 and of the wound hooping assembly 76 lying axially between the axial edges 76A, 76B of the wound hooping assembly 76, paired angles different in absolute value.

The portion AC′ of the assembly 58 and of the wound hooping assembly lying axially between the axial edges 76A, 76B of the wound hooping assembly 76 has an axial width equal to at least 40%, preferably at least 50%, of the axial width L of the wound working assembly 50 and at most 90%, preferably at most 80%, of the axial width L of the wound working assembly 50 and in this case here 60% of the axial width L of the wound working assembly 50. The median plane m of the assembly 58 intersects this portion AC′. More preferably, this portion AC′ is axially centred on the median plane m of the assembly 58.

Then, a strip of polymeric material intended to form the tread 20 is arranged, radially outside the wound hooping assembly 76, so as to form a green blank of the tyre 10. In one variant, the strip of polymeric material intended to form the tread 20 may be arranged radially outside the hooping assembly 76, then this assembly may be transferred radially outside the assembly 58 previously formed on the support 60. In another variant, it is possible, after having arranged the wound hooping assembly 76 radially around the assembly 58 previously formed on the support 60, to arrange the strip of polymeric material intended to form the tread 20.

Then, the green blank of the tyre 10 formed from the previously formed assembly 58 and the wound hooping assembly 76 is moulded by radially and circumferentially expanding the green blank so as to press a radially external surface of the green blank against a moulding wall of a crosslinking mould.

Then, the green blank is crosslinked in the crosslinking mould so as to obtain the tyre 10, for example by vulcanization.

Comparative Tests

For the purposes of the invention, the most relevant descriptor for evaluating the rolling resistance of tyres comprising a single working layer was determined first of all. For this, we correlated, using various correlation functions conventionally used by those skilled in the art, for example linear, quadratic or cubic functions (Function 1, Function 2, Function 3, Function 4), the correlation between the tangent modulus of the hoop reinforcement and the rolling resistance simulated on tyres comprising a single working layer similar to the tyre 10 described above and comprising various hooping filamentary reinforcing elements. Thus, rolling resistance simulations were carried out for hooping filamentary reinforcing elements having different tangent modulus values. Then, the various forces for which this tangent modulus can be calculated were scanned. Then, it was sought to pass each correlation function into the simulated rolling resistance point cloud and the correlation coefficient R2 was recorded for each of the correlation functions at each level of force. The results of these simulations are shown in FIG. 17. A similar approach was carried out by scanning various elongations for which the tangent modulus can be calculated. The results of these simulations are shown in FIG. 18. From these FIGS. 17 and 18, we note that the most relevant descriptor is the tangent modulus M13% at an elongation equal to 1.3% correlated using the correlation function 1.

The same approach was reproduced for a conventional tyre of the prior art comprising a carcass layer comprising carcass filamentary reinforcing elements extending in a main direction forming, with the circumferential direction of the tyre, a substantially constant angle equal to 90° and two working layers comprising working filamentary reinforcing elements. The main direction in which each working filamentary reinforcing element of the radially innermost working layer extends and the main direction in which each working filamentary reinforcing element of the radially outermost working layer extends form, with the circumferential direction of the tyre, angles of opposite orientations and equal, in absolute value, to 26°. The results of these simulations are shown in FIGS. 19 and 20. We note that the most relevant descriptor is the tangent modulus M1% at an elongation equal to 1% correlated using the correlation function 1.

Table 1 below compiles the tangent moduli M13% at 1.3% of nine hooping filamentary reinforcing elements as well as the corresponding rolling resistance RR13 of a tyre comprising a single working layer similar to those simulated. Table 1 below also compiles the tangent moduli M1% at 1% elongation simulated for hooping assemblies comprising the same nine hooping filamentary reinforcing elements as well as the corresponding rolling resistance R1 of a tyre comprising two working layers similar to those simulated.

Element 1 is the hooping filamentary reinforcing element 170 described above.

Element 2 consists of two multifilament strands of aromatic polyamide of 250 tex each and of one multifilament strand of aliphatic polyamide of 140 tex wound individually then together in a helix with a twist equal to 300 turns per metre.

Element 3 consists of two multifilament strands of aromatic polyamide of 250 tex each and of one multifilament strand of aliphatic polyamide of 210 tex wound individually then together in a helix with a twist equal to 300 turns per metre.

Element 4 consists of two multifilament strands of aromatic polyamide of 250 tex each and of one multifilament strand of polyethylene terephthalate of 220 tex wound individually then together in a helix with a twist equal to 300 turns per metre.

Element 5 consists of two multifilament strands of aromatic polyamide of 167 tex each and of one multifilament strand of aliphatic polyamide of 140 tex wound individually then together in a helix with a twist equal to 360 turns per metre.

Element 6 consists of three multifilament strands of polyethylene terephthalate of 440 tex each wound individually then together in a helix with a twist equal to 160 turns per metre.

Elements 7 and 8 have a “Core Insertion” type structure as described in WO2019/122621. Element 7 comprises an aliphatic polyamide core strand of 47 tex individually wound at 340 turns per metre and three aromatic polyamide layer strands of 167 tex each individually wound at 315 turns per metre, the core and layer strands being wound together at 315 turns per metre. Element 8 comprises an aliphatic polyamide core strand of 47 tex individually wound at 300 turns per metre and three aromatic polyamide layer strands of 167 tex each individually wound at 270 turns per metre, the core and layer strands being wound together at 270 turns per metre.

Element 9 has a triple twist structure A110/1/2/3 as described in WO2019/180367.

TABLE 1

| | M13% | RR13 | M1% | RR1 |
|---|---|---|---|---|
| | (daN/mm) | (kg/t) | (daN/mm) | (kg/t) |
| Element 1 | 322 | 5.31 | 314 | 5.91 |
| Element 2 | 349 | 5.31 | 332 | 5.92 |
| Element 3 | 226 | 5.34 | 218 | 5.89 |
| Element 4 | 434 | 5.32 | 398 | 5.95 |
| Element 5 | 222 | 5.33 | 218 | 5.89 |
| Element 6 | 297 | 5.32 | 291 | 5.91 |
| Element 7 | 40 | 5.43 | 36 | 5.95 |
| Element 8 | 112 | 5.39 | 101 | 5.93 |
| Element 9 | 935 | 5.39 | 887 | 6.10 |

It should be noted that, in a conventional tyre comprising two working layers, elements 1 to 6 do not make it possible to obtain significantly improved rolling resistance (by significantly improved is meant here lower by at least 0.05 kg·t) in relation to elements 7 to 9, and particularly in relation to elements 7 and 8. By contrast, and unexpectedly, these elements 1 to 6 make it possible to obtain a significantly improved rolling resistance (lower by at least 0.05 kg·t) in relation to elements 7 to 9 in a tyre comprising a single working layer. Thus, even having tangent moduli at 1% elongation significantly different in relation to elements 7 to 9, it was impossible to suspect that elements 1 to 6 could make it possible to improve the rolling resistance of tyres according to the invention.

The same approach was also reproduced in order to determine the capacity of the tyre to reach and contain the expected volume under a predetermined inflation pressure. For this, in a similar way to the rolling resistance, we correlated, using various correlation functions (Function 1, Function 2, Function 3, Function 4), the correlation between the tangent modulus of the hoop reinforcement and the radial elongation CF of tyres comprising a single working layer similar to the tyre 10 under a pressure of 2.5 bar and comprising various hooping filamentary reinforcing elements. The same was done with tyres comprising two working layers. The results of this study showed that:
the most relevant descriptor for simulating the capacity of a tyre comprising a single working layer to achieve and contain the expected volume under a predetermined inflation pressure was the tangent modulus M2D at a force of 2 daN/mm, and
the most relevant descriptor for simulating the capacity of a tyre comprising two working layers to achieve and contain the expected volume under a predetermined inflation pressure was the tangent modulus M1D at a force of 1 daN/mm.

The simulation results of the tyres comprising the hooping filamentary reinforcing elements 1 to 9 are compiled in Table 2.

TABLE 2

| | M2D | CF2 | M1D | CF1 |
|---|---|---|---|---|
| | (daN/mm) | (mm) | (daN/mm) | (mm) |
| Element 1 | 300 | 4.8 | 264 | 2.4 |
| Element 2 | 315 | 4.8 | 290 | 2.3 |
| Element 3 | 218 | 4.9 | 195 | 3.3 |
| Element 4 | 312 | 4.5 | 248 | 2.3 |
| Element 5 | 216 | 4.9 | 210 | 3.2 |
| Element 6 | 274 | 4.9 | 283 | 1.1 |
| Element 7 | 110 | 4.1 | 50 | 8.4 |
| Element 8 | 131 | 4.5 | 100 | 5.4 |
| Element 9 | 787 | 2.6 | 715 | 0.8 |

It should be noted that, for a conventional tyre comprising two working layers, elements 1 to 6 present a risk of not reaching the expected volume, in particular with respect to element 8. By contrast, and unexpectedly, these elements 1 to 6 make it possible to reach the expected volume without the risk of not containing it, unlike element 9 which would not make it possible to obtain the expected volume for a tyre comprising a single working layer. Thus, even having tangent moduli at 1% elongation significantly different in relation to elements 7 to 9, it was impossible to suspect that elements 1 to 6 could make it possible to achieve and contain the expected volume of the tyre under a predetermined inflation pressure.

The invention is not limited to the embodiments described above.

Specifically, it is possible in particular to implement the invention by using two carcass layers instead of a single carcass layer.

In addition, as for element 6 described above, it is also possible to envisage a variant in which the or each hooping filamentary reinforcing element consists of three polyester multifilament strands. Preferably, in this variant, the count of each polyester multifilament strand ranges from 300 tex to 500 tex, for example is equal to 440 tex, and the assembly twist of the three polyester multifilament strands around the common main axis ranges from 100 turns per metre to 250 turns per metre, for example is equal to 160 turns per metre. The twist coefficient K of the or each hooping filamentary reinforcing element of this variant ranges from 120 to 260, preferably from 130 to 200 and even more preferably from 130 to 160, for example is equal to 156.

1.-14. (canceled)

15. A tire (10) comprising a crown (12), two sidewalls (22) and two beads (24), each sidewall (22) connecting each bead (24) to the crown (12), the tire (10) comprising a carcass reinforcement (32) anchored in each bead (24) and extending in each sidewall (22) and radially internally at the crown (12), the carcass reinforcement (32) comprising a carcass layer (34), the crown (12) comprising:
a tread (20) intended to come into contact with a ground when the tire (10) is rolling; and
a crown reinforcement (14) arranged radially between the tread (20) and the carcass reinforcement (32), the crown reinforcement (14) comprising:
a working reinforcement (16) comprising a single working layer (18); and
a hoop reinforcement (17) arranged radially outside the working reinforcement (16), the hoop reinforcement (17) being axially delimited by two axial edges (17A, 17B) of the hoop reinforcement (17) and comprising at least one hooping filamentary reinforcing element (170) wound circumferentially helically so as to extend axially from one axial edge (17A, 17B) to the other axial edge (17A, 17B) of the hoop reinforcement (17),
wherein the or each hooping filamentary reinforcing element (170) consists of:
two multifilament strands (1701, 1702) of aromatic polyamide or aromatic copolyamide and one multifilament strand (1703) of aliphatic polyamide or of polyester; or
three polyester multifilament strands,
each multifilament strand (1701, 1702, 1703) being wound in a helix around a main axis (W) common to the three multifilament strands (1701, 1702, 1703), and
wherein the hoop reinforcement (17) has a tangent modulus (M13%) at 1.3% elongation ranging from 200 to 650 daN/mm.

16. The tire (10) according to claim 15, wherein the or each hooping filamentary reinforcing element (170) consists of two multifilament strands (1701, 1702) of aromatic polyamide or aromatic copolyamide and of one multifilament strand (1703) of aliphatic polyamide or of polyester, each multifilament strand (1701, 1702, 1703) being wound in a helix around a main axis (W) common to the three multifilament strands (1701, 1702, 1703).

17. The tire (10) according to claim 15, wherein a ratio of a total count, expressed in tex, of aromatic polyamide or aromatic copolyamide to a total count, expressed in tex, of the or each hooping filamentary reinforcing element (170) ranges from 0.60 to 0.90.

18. The tire (10) according to claim 15, wherein the hoop reinforcement (17) has a tangent modulus (M13%) at 1.3% elongation greater than or equal to 220 daN/mm.

19. The tire according to claim 15, wherein the hoop reinforcement (17) has a tangent modulus (M13%) at 1.3% elongation less than or equal to 600 daN/mm.

20. The tire (10) according to claim 15, wherein the hoop reinforcement (17) develops, under a force equal to 2 daN/mm, a tangent modulus (M2D) ranging from 150 to 400 daN/mm.

21. The tire (10) according to claim 20, wherein the hoop reinforcement (17) develops, under a force equal to 2 daN/mm, a tangent modulus (M2D) greater than or equal to 200 daN/mm.

22. The tire (10) according to claim 20, wherein the hoop reinforcement (17) develops, under a force equal to 2 daN/mm, a tangent modulus (M2D) less than or equal to 350 daN/mm.

23. The tire according to claim 15, wherein a twist coefficient K of the or each hooping filamentary reinforcing element (170) defined by the relation K=R×[(T/(1000·ρ)]½, where R is an assembly twist of the three multifilament strands (1701, 1702, 1703) around the common main axis (W), expressed in turns per meter, T is a total count of the or each hooping filamentary reinforcing element (170) expressed in tex, and ρ is an average density of the material constituting the or each hooping filamentary reinforcing element (170), ranges from 140 to 260.

24. The tire (10) according to claim 15, wherein the or each hooping filamentary reinforcing element (170) extends axially from one axial edge (17A, 17B) to the other axial edge (17A, 17B) of the hoop reinforcement (17) in a main direction (D1) of the or each hooping filamentary reinforcing element (170) forming, with the circumferential direction (Z) of the tire (10), an angle (AF), in absolute value, less than or equal to 10°.

25. The tire (10) according to claim 15, wherein the working layer (18) is delimited axially by two axial edges (18A, 18B) of the working layer (18) and comprises working filamentary reinforcing elements (180) extending axially from one axial edge (18A, 18B) to the other axial edge (18A, 18B) of the working layer (18) substantially parallel to one another in a main direction (D2) of each working filamentary reinforcing element (180), the main direction (D2) of each working filamentary reinforcing element (180) of the working layer (18) forming, with the circumferential direction (Z) of the tire (10), an angle (AT), in absolute value, strictly greater than 10°.

26. The tire (10) according to claim 15, wherein the or each carcass layer (34) is delimited axially by two axial edges (34A, 34B) of the or each carcass layer (34) and comprises carcass filamentary reinforcing elements (340) extending axially from one axial edge (34A, 34B) to the other axial edge (34A, 34B) of the or each carcass layer (34), each carcass filamentary reinforcing element (340) extending in a main direction (D3) of each carcass filamentary reinforcing element (340), the main direction (D3) of each carcass filamentary reinforcing element (340) of the or each carcass layer (34) forming, with the circumferential direction (Z) of the tire (10):
an angle (ACS), in absolute value, strictly less than 80° in a portion (34S) of the carcass layer (34) extending axially in radial line with the working layer (18), and
an angle (ACF), in absolute value, ranging from 80° to 90° in at least one portion (34F) of the carcass layer (34) extending radially in each sidewall (22).

27. The tire (10) according to claim 26, wherein the main direction (D3) of each carcass filamentary reinforcing element (340) forms, with the circumferential direction (Z) of the tire (10), an angle (ACS), in absolute value, greater than or equal to 10°, in the portion (34S) of the carcass layer (34) extending axially in radial line with the working layer (18).

28. A method for producing a tire (10) according to claim 15 comprising the steps:
winding a carcass ply (51) or a plurality of carcass plies (51) around a support (60) having a substantially cylindrical shape around a main axis (A), to form one or more wound carcass assemblies (52), the wound carcass assemblies (52) being intended to form the carcass layer (34);
winding a working ply (49) or a plurality of working plies (50), radially outside the wound carcass assembly(ies) (52), to form a wound working assembly (50) intended to form the working layer (18),
the wound carcass assemblies (52) and the wound working assembly (50) forming an assembly (58) of substantially cylindrical shape around the main axis (A) of the support (60),
the assembly (58) of substantially cylindrical shape around the main axis (A) of the support (60) is deformed so as to obtain an assembly (58) of substantially toric shape around the main axis (A) of the support (60); and
after the deformation step, arranging radially around the assembly (58) of substantially toric shape around the main axis (A) of the support (60), a wound hooping assembly (76) intended to form the hoop reinforcement (17), the wound hooping assembly (76) being formed by helical winding of the or each hooping filamentary reinforcing element (170) or of a hooping ply (74) obtained by embedding the or each hooping filamentary reinforcing element (170) in an elastomeric matrix.
